(19) United States
(12) Patent Application Publication
(10) Pub. No.: US 2025/0287170 A1
(43) Pub. Date: Sep. 11, 2025

(54) APPARATUS AND METHOD EMPLOYING A PERCEPTION-BASED DISTANCE METRIC FOR SPATIAL AUDIO

(71) Applicant: Fraunhofer-Gesellschaft zur Förderung der angewandten Forschung e.V., München (DE)

(72) Inventors: Sascha DICK, Erlangen (DE); Jürgen HERRE, Erlangen (DE); Pablo Manuel DELGADO, Erlangen (DE)

(73) Assignee: Fraunhofer-Gesellschaft zur Förderung der angewandten Forschung e.V., München (DE)

(21) Appl. No.: 19/093,283

(22) Filed: Mar. 28, 2025

Related U.S. Application Data
(63) Continuation of application No. PCT/EP2023/076859, filed on Sep. 28, 2023.

(30) Foreign Application Priority Data
Sep. 29, 2022 (EP) 22198848.8

(51) Int. Cl. H04S 7/00

(52) U.S. Cl. CPC H04S 7/302; H04S 2420/01; H04S 2420/03

(57) ABSTRACT

An apparatus according to an embodiment is provided. The apparatus comprises an input interface for receiving a plurality of audio objects of an audio sound scene. Moreover, the apparatus comprises a processor. Each of the plurality of audio objects represents a sound source being different from any other sound source being represented by any other audio object of the plurality of audio objects; or at least two of the plurality of audio objects represent a same sound source at different locations. The processor is configured to obtain information on a perceptual difference between two audio objects of the plurality of audio objects depending on a distance metric, wherein the distance metric represents perceptual differences in spatial properties of the audio sound scene. And/or, the processor is configured to process the plurality of audio objects to obtain a plurality of audio object clusters or a plurality of processed audio objects depending on the distance metric.

### CROSS-REFERENCES TO RELATED APPLICATIONS

This application is a continuation of copending International Application No. PCT/EP2023/076859, filed Sep. 28, 2023, which is incorporated herein by reference in its entirety, and additionally claims priority from European Application No. EP 22198848.8, filed Sep. 29, 2022, which is incorporated herein by reference in its entirety.

The present invention relates to an apparatus and a method employing a perception-based distance (distortion) metric for spatial audio.

### BACKGROUND OF THE INVENTION

Modern audio reproduction systems enable an immersive, three-dimensional (3D) sound experience.

One common format for 3D sound reproduction is channel-based audio, where individual channels associated to defined loudspeaker positions are produced via multi-microphone recordings or studio-based production. Another common format for 3D sound reproduction is object-based audio, which utilizes so-called audio objects, which are placed in the listening room by the producer and are converted to loudspeaker or headphone signals by a rendering system for playback. Object-based audio allows a high flexibility when it comes to design and reproduction of sound scenes. Note that channel-based audio may be considered to be a special case of object-based audio, where sound sources (=objects) are positioned in fixed positions that correspond to the defined loudspeaker positions.

To increase efficiency of transmission and storage of object-based immersive sound scenes, as well as to reduce computational requirements for real-time rendering, it is beneficial or even required to reduce or limit the number of audio objects. This is achieved by identifying groups or clusters of neighboring audio objects and combining them into a lower number of sound sources. This process is called object clustering or object consolidation.

It has been shown in literature, that the localization accuracy of human hearing is limited and dependent on the sound source position (e.g. horizontal localization is more accurate than vertical localization), and that auditory masking effects can be observed between spatially distributed sound sources. By exploiting those limitations of localization accuracy in human hearing and auditory masking effects for object clustering, a significant reduction in the number of audio objects can be achieved while maintaining high perceptual quality.

Auditory masking and localization models are known in the art.

Directional loudness maps (DLM) have been presented in: C. Avendano, “Frequency-domain source identification and manipulation in stereo mixes for enhancement, suppression and re-panning applications,” in 2003 IEEE Workshop on Applications of Signal Processing to Audio; and in: P. Delgado, J. Herre, “Objective Assessment of Spatial Audio Quality using Directional Loudness Maps”, in Proc. 2019 IEEE ICASSP.

Object clustering algorithms have been presented in J. Herder. “Optimization of Sound Spatialization Resource Management through Clustering”, The Journal of Three Dimensional Images, 1999; and in: Nicolas Tsingos, Emmanuel Gallo, George Drettakis: “Perceptual Audio Rendering of Complex Virtual Environments”, SIGGRAPH, 2004; and in: Breebaart, Jeroen; Cengarle, Giulio; Lu, Lie; Mateos, Toni; Purnhagen, Heiko; Tsingos, Nicolas: “Spatial Coding of Complex Object-Based Program Material”; JAES Volume 67 Issue 7/8 pp. 486-497; July 2019.

The state of the art comprises psychoacoustic models for localization cues, masking and saliency. However, it does not provide a method to estimate the perceptual impact of changes to the spatial properties of individual sound sources in a scene relative to the listener's position, in a computationally efficient representation that is suitable for real-time applications such as audio for virtual reality (VR).

### SUMMARY

An embodiment may have an apparatus, comprising: an input interface for receiving a plurality of audio objects of an audio sound scene, and a processor, wherein each of the plurality of audio objects represents a sound source being different from any other sound source being represented by any other audio object of the plurality of audio objects; or wherein at least two of the plurality of audio objects represent a same sound source at different locations; wherein the processor is configured to acquire information on a perceptual difference between two audio objects of the plurality of audio objects depending on a distance metric, wherein the distance metric represents perceptual differences in spatial properties of the audio sound scene; and/or wherein the processor is configured to process the plurality of audio objects to acquire a plurality of audio object clusters or a plurality of processed audio objects depending on the distance metric.

Another embodiment may have a system, comprising: an apparatus according to the invention, a decoding unit, and a signal generator, wherein the decoding unit is configured to decode the encoded information to acquire the plurality of audio object clusters or the plurality of processed audio objects; and wherein the signal generator is configured to generate two or more audio output signals depending on the plurality of audio object clusters or depending on the plurality of processed audio objects; and/or wherein the decoding unit is configured to decode the encoded information to acquire a plurality of audio objects of the audio sound scene and to acquire information on a perceptual difference between two audio objects of the plurality of audio objects; and wherein the signal generator is configured to generate the two or more audio output signals depending on the plurality of audio objects and depending on the perceptual difference between said two audio objects.

Another embodiment may have a decoder, comprising: a decoding unit; and a signal generator; wherein each of a plurality of audio objects of an audio sound scene represents a sound source being different from any other sound source being represented by any other audio object of the plurality of audio objects; or at least two of the plurality of audio objects represent a same sound source at different locations; wherein the decoding unit is configured to decode encoded information to acquire a plurality of audio object clusters or a plurality of processed audio objects; wherein the plurality of audio object clusters or the plurality of processed audio objects depends on the plurality of audio objects of the audio sound scene and depends on a distance metric that represents perceptual differences in spatial properties of the audio sound scene; and wherein the signal generator is configured to generate two or more audio output signals depending on the plurality of audio object clusters or depending on the plurality of processed audio objects; and/or wherein the decoding unit is configured to decode the encoded information to acquire the plurality of audio objects of the audio sound scene and to acquire information on a perceptual difference between two audio objects of the plurality of audio objects, wherein the perceptual difference depends on a distance metric; and wherein the signal generator is configured to generate the two or more audio output signals depending on the plurality of audio objects and depending on the perceptual difference between said two audio objects.

Another embodiment may have a method, comprising: receiving a plurality of audio objects of an audio sound scene, and acquiring information on a perceptual difference between two audio objects of the plurality of audio objects depending on a distance metric, wherein each of the plurality of audio objects represents a sound source being different from any other sound source being represented by any other audio object of the plurality of audio objects; or wherein at least two of the plurality of audio objects represent a same sound source at different locations; wherein the distance metric represents perceptual differences in spatial properties of the audio sound scene; and/or processing the plurality of audio objects to acquire a plurality of audio object clusters or a plurality of processed audio objects depending on the distance metric.

Another embodiment may have a method, wherein each of the plurality of audio objects represents a sound source being different from any other sound source being represented by any other audio object of the plurality of audio objects; or at least two of the plurality of audio objects represent a same sound source at different locations; wherein the method comprises: decoding encoded information to acquire a plurality of audio object clusters or a plurality of processed audio objects; wherein the plurality of audio object clusters or the plurality of processed audio objects depends on the plurality of audio objects of the audio sound scene and depends on a distance metric that represents perceptual differences in spatial properties of the audio sound scene; and generating two or more audio output signals depending on the plurality of audio object clusters or depending on the plurality of processed audio objects; and/or decoding the encoded information to acquire the plurality of audio objects of the audio sound scene and to acquire information on a perceptual difference between two audio objects of the plurality of audio objects, wherein the perceptual difference depends on a distance metric; and generating the two or more audio output signals depending on the plurality of audio objects and depending on the perceptual difference between said two audio objects.

Another embodiment may have a non-transitory digital storage medium having a computer program stored thereon to perform the method comprising: receiving a plurality of audio objects of an audio sound scene, and acquiring information on a perceptual difference between two audio objects of the plurality of audio objects depending on a distance metric, wherein each of the plurality of audio objects represents a sound source being different from any other sound source being represented by any other audio object of the plurality of audio objects; or wherein at least two of the plurality of audio objects represent a same sound source at different locations; wherein the distance metric represents perceptual differences in spatial properties of the audio sound scene; and/or processing the plurality of audio objects to acquire a plurality of audio object clusters or a plurality of processed audio objects depending on the distance metric, when said computer program is run by a computer. 24. A non-transitory digital storage medium having a computer program stored thereon to perform the method, wherein each of the plurality of audio objects represents a sound source being different from any other sound source being represented by any other audio object of the plurality of audio objects; or at least two of the plurality of audio objects represent a same sound source at different locations; wherein the method comprises: decoding encoded information to acquire a plurality of audio object clusters or a plurality of processed audio objects; wherein the plurality of audio object clusters or the plurality of processed audio objects depends on the plurality of audio objects of the audio sound scene and depends on a distance metric that represents perceptual differences in spatial properties of the audio sound scene; and generating two or more audio output signals depending on the plurality of audio object clusters or depending on the plurality of processed audio objects; and/or decoding the encoded information to acquire the plurality of audio objects of the audio sound scene and to acquire information on a perceptual difference between two audio objects of the plurality of audio objects, wherein the perceptual difference depends on a distance metric; and generating the two or more audio output signals depending on the plurality of audio objects and depending on the perceptual difference between said two audio objects, when said computer program is run by a computer.

An apparatus according to an embodiment is provided. The apparatus comprises an input interface for receiving a plurality of audio objects of an audio sound scene. Moreover, the apparatus comprises a processor. Each of the plurality of audio objects represents a (real or virtual) sound source being different from any other (real or virtual) sound source being represented by any other audio object of the plurality of audio objects; or at least two of the plurality of audio objects represent a same (real or virtual) sound source at different locations. The processor is configured to obtain information on a perceptual difference between two audio objects of the plurality of audio objects depending on a distance metric, wherein the distance metric represents perceptual differences in spatial properties of the audio sound scene. And/or, the processor is configured to process the plurality of audio objects to obtain a plurality of audio object clusters or a plurality of processed audio objects depending on the distance metric.

Moreover, a decoder according to an embodiment is provided. The decoder comprises a decoding unit and a signal generator. Each of a plurality of audio objects of an audio sound scene represents a (real or virtual) sound source being different from any other (real or virtual) sound source being represented by any other audio object of the plurality of audio objects; or at least two of the plurality of audio objects represent a same (real or virtual) sound source at different locations. The decoding unit is configured to decode encoded information to obtain a plurality of audio object clusters or a plurality of processed audio objects; wherein the plurality of audio object clusters or the plurality of processed audio objects depends on the plurality of audio objects of the audio sound scene and depends on a distance metric that represents perceptual differences in spatial properties of the audio sound scene; and the signal generator is configured to generate two or more audio output signals depending on the plurality of audio object clusters or depending on the plurality of processed audio objects. And/or, the decoding unit is configured to decode the encoded information to obtain the plurality of audio objects of the audio sound scene and to obtain information on a perceptual difference between two audio objects of the plurality of audio objects, wherein the perceptual difference depends on a distance metric; and the signal generator is configured to generate the two or more audio output signals depending on the plurality of audio objects and depending on the perceptual difference between said two audio objects.

Furthermore, a method according to an embodiment is provided. The method comprises:
Receiving information on a plurality of audio objects of an audio sound scene, and
Obtaining information on a perceptual difference between two audio objects of the plurality of audio objects depending on a distance metric.

Each of the plurality of audio objects represents a (real or virtual) sound source being different from any other (real or virtual) sound source being represented by any other audio object of the plurality of audio objects; or at least two of the plurality of audio objects represent a same (real or virtual) sound source at different locations. The distance metric represents perceptual differences in spatial properties of the audio sound scene; and/or processing a plurality of audio objects to obtain a plurality of audio object clusters or a plurality of processed audio objects depending on the distance metric.

Moreover, a method according to another embodiment is provided. Each of a plurality of audio objects of an audio sound scene represents a (real or virtual) sound source being different from any other (real or virtual) sound source being represented by any other audio object of the plurality of audio objects; or at least two of the plurality of audio objects represent a same (real or virtual) sound source at different locations. The method comprises:
Decoding encoded information to obtain a plurality of audio object clusters or a plurality of processed audio objects; wherein the plurality of audio object clusters or the plurality of processed audio objects depends on the plurality of audio objects of the audio sound scene and depends on a distance metric that represents perceptual differences in spatial properties of the audio sound scene; and generating two or more audio output signals depending on the plurality of audio object clusters or depending on the plurality of processed audio objects. And/or:
Decoding the encoded information to obtain the plurality of audio objects of the audio sound scene and to obtain information on a perceptual difference between two audio objects of the plurality of audio objects, wherein the perceptual difference depends on a distance metric; and generating the two or more audio output signals depending on the plurality of audio objects and depending on the perceptual difference between said two audio objects.

Moreover, computer programs are provided, wherein each of the computer programs is configured to implement one of the above-described methods when being executed on a computer or signal processor.

In order to predict the perceivable impact of localization changes in a sound scenes, according to some embodiments, a perceptual model has been provided that represents perceptual differences in a computationally efficient way. This model can be utilized to optimize the perceptual quality of clustering algorithms for object based audio, as well as an objective measurement quantify perceivable differences between different representations of a sound scene.

The perceptual distance metric according to some embodiments obtains answers to questions like: How perceptible is it if the position of a sound source changes? How perceptible is the difference between two different sound scene representations? How important is a given sound source within an entire sound scene? (And how noticeable would it be to remove it?)

The psychoacoustic model according to some embodiments may, e.g., comprise one or more of the following components that correspond to different aspects of human perception, namely a perceptual coordinate system, a 3D directional loudness map, a spatial masking model and a perceptual distance metric.

According to some embodiments, a perceptual coordinate system (PCS) is provided. Source localization accuracy in humans varies for different spatial directions. In order to represent this in a computationally efficient way, a perceptual coordinate system (PCS) is introduced. To obtain this PCS, spatial positions are warped to correspond to the non-uniform characteristics of localization accuracy. Thereby, distances in the PCS correspond to a “perceived distance” between positions, e.g., the number of just noticeable differences (JND), rather than physical distance. This principle is similar to the use of psychoacoustic frequency scales in perceptual audio coding, e.g., a Bark-Scale or an ERB-Scale (Equivalent Rectangular Bandwidth-Scale).

According to some embodiments, a 3D directional loudness map (3D-DLM) is provided. The underlying idea of a directional loudness map (DLM) is to find a representation of “how much loudness is perceived to be coming from a given direction”. This concept has already been presented as a 1-dimensional approach to represent binaural localization in a binaural DLM (Delgado et al. 2019). This concept is now extended to 3-dimensional (3D) localization by creating a 3D-DLM on a surface surrounding the listener to uniquely represent the perceived loudness depending on the angle of incidence relative to the listener. It should be noted, that the binaural DLM had been obtained by analysis of the signals at the ears, whereas the 3D-DLM is synthesized for object-based audio by utilizing the a-priori known sound source positions and signal properties.

In some embodiments, a spatial masking model (SMM) is provided. Monaural time-frequency auditory masking models are a fundamental element of perceptual audio coding, and are often enhanced by binaural (un-)masking models to improve stereo coding. The spatial masking model extends this concept for immersive audio, in order to incorporate and exploit masking effects between arbitrary sound source positions in 3D.

According to some embodiments, a perceptual distance metric is provided. It is noted that the abovementioned components may, e.g., be combined to obtain perception-based distance metrics between spatially distributed sound sources. These can be utilized in a variety of applications, e.g., as cost functions in an object-clustering algorithm, to control bit distribution in a perceptual audio coder and for obtaining objective quality measurements.

### BRIEF DESCRIPTION OF THE DRAWINGS

Embodiments of the present invention will be detailed subsequently referring to the appended drawings, in which:

FIG. 1 illustrates an apparatus according to an embodiment.

FIG. 2 illustrates a decoder according to an embodiment.

FIG. 3 illustrates a system according to an embodiment.

FIG. 4 illustrates a two-dimensional example for a perceptual coordinate system coordinate warping is illustrated according to an embodiment.

FIG. 5 illustrates perceptual coordinates obtained via a multidimensional scaling of modeled differences in a CIPIC HRTF database according to an embodiment.

FIG. 6 illustrates a polynomial model based perceptual coordinate system according to an embodiment.

FIG. 7 illustrates an ellipsoid model based perceptual coordinate system according to an embodiment.

FIG. 8 illustrates an example for the synthesis of a one-dimensional directional loudness map based on known object positions and loudness according to an embodiment.

FIG. 9A and FIG. 9B illustrate an example for a 3D-directional loudness map synthesized from known sound source positions according to embodiments.

FIG. 10A and FIG. 10B illustrate different sampling methods of a unit sphere grid according to embodiments, wherein (a) depicts an azimuth/elevation sampling, and wherein (b) depicts an icosphere.

FIG. 11 illustrates a masking model calculation in perceptual coordinates according to an embodiment.

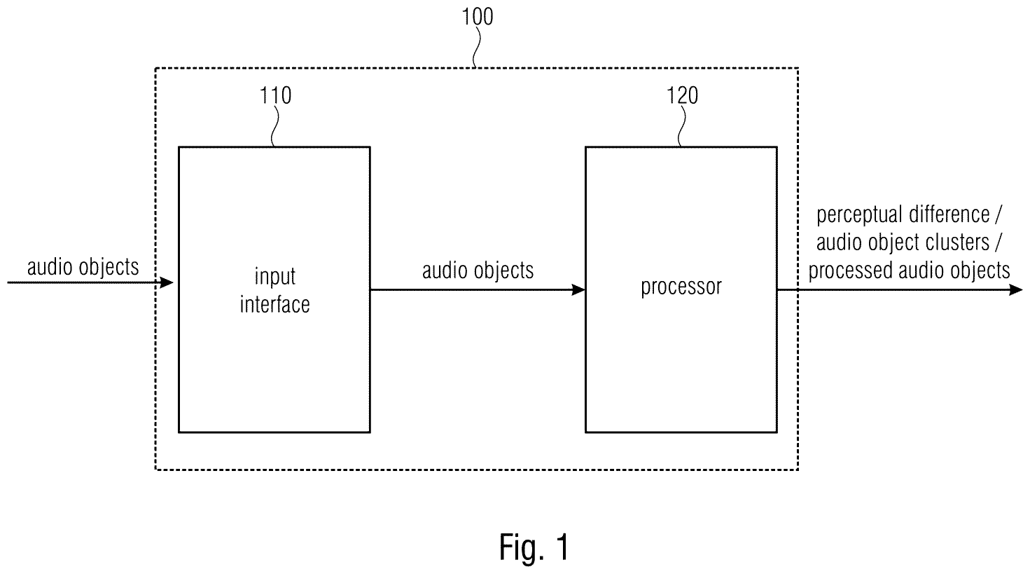

FIG. 1 illustrates an apparatus 100 according to an embodiment.

### DETAILED DESCRIPTION OF THE INVENTION

An apparatus 100 according to an embodiment is provided.

The apparatus comprises an input interface 110 for receiving a plurality of audio objects of an audio sound scene.

Moreover, the apparatus 100 comprises a processor 120.

Each of the plurality of audio objects represents a real or virtual sound source being different from any other real or virtual sound source being represented by any other audio object of the plurality of audio objects; or at least two of the plurality of audio objects represent a same real sound source or a same virtual sound source at different locations. For example, a same real or virtual sound source may be considered at different locations, because different points-in-time are considered. Or, a same real or virtual sound source may be considered at different locations because a location before position quantization may, e.g., compared with a location after position quantization.

The processor 120 is configured to obtain information on a perceptual difference between two audio objects of the plurality of audio objects depending on a distance metric. The distance metric represents perceptual differences in spatial properties of the audio sound scene.

And/or, the processor 120 is configured to process a plurality of audio objects to obtain the plurality of audio object clusters or a plurality of processed audio objects depending on the distance metric.

According to an embodiment, the audio sound scene may, e.g., be a three-dimensional audio sound scene.

In an embodiment, the processor 120 may, e.g., be configured to obtain the information on a perceptual difference between two audio objects depending on a perceptual coordinate system; and/or wherein the processor 120 may, e.g., be configured to process the plurality of audio objects to obtain the plurality of audio object clusters or the plurality of processed audio objects depending on the perceptual coordinate system. Distances in the perceptual coordinate system represent perceivable localization differences.

According to an embodiment, the processor 120 may, e.g., be configured to obtain the information on a perceptual difference between two audio objects depending on an invertible mapping function; and/or wherein the processor 120 may, e.g., be configured to process the plurality of audio objects to obtain the plurality of audio object clusters or the plurality of processed audio objects depending on the invertible mapping function. Moreover, the processor 120 may, e.g., be configured to employ the invertible mapping function to transform coordinates of a physical coordinate system into coordinates of the perceptual coordinate system.

In an embodiment, the invertible mapping function may, e.g., depend on head-related transfer function data.

According to an embodiment, the processor 120 may, e.g., be configured to obtain the information on a perceptual difference between two audio objects depending on a spatial masking model for spatially distributed sound sources; and/or wherein the processor 120 may, e.g., be configured to process the plurality of audio objects to obtain the plurality of audio object clusters or the plurality of processed audio objects depending on the spatial masking model. The spatial masking model may, e.g., depend on a masking threshold. The processor 120 may, e.g., be configured to determine the masking threshold depending on a falloff function, and depending on one or more distances in the perceptual coordinate system.

In an embodiment, the processor 120 may, e.g., be configured to determine the masking threshold depending on a Gaussian-shaped falloff function as the falloff function and depending on an offset for minimum masking.

According to an embodiment, the processor 120 may, e.g., be configured to identify one or more inaudible audio objects among the plurality of audio objects.

In an embodiment, the processor 120 may, e.g., be configured to obtain the information on a perceptual difference between two audio objects depending on a perceptual distortion metric; and/or wherein the processor 120 may, e.g., be configured to process the plurality of audio objects to obtain the plurality of audio object clusters or the plurality of processed audio objects depending on the perceptual distortion metric. Moreover, the processor 120 may, e.g., be configured to determine the perceptual distortion metric depending on distances in the perceptual coordinate system and depending on the spatial masking model.

According to an embodiment, the processor 120 may, e.g., be configured to determine the perceptual distortion metric depending on a perceptual entropy of one or more of the plurality of audio objects.

In an embodiment, the processor 120 may, e.g., be configured to determine the perceptual distortion metric depending on a first distance between a first one of two audio objects of the plurality of audio objects and a centroid of the two audio objects, and depending on a second distance between a second one of the two audio objects and the centroid of the two audio objects.

According to an embodiment, the processor 120 may, e.g., be configured to obtain the information on a perceptual difference between two audio objects depending on a three-dimensional directional loudness map; and/or wherein the processor 120 may, e.g., be configured to process the plurality of audio objects to obtain the plurality of audio object clusters or the plurality of processed audio objects depending on the directional loudness map. The three-dimensional directional loudness map may, e.g., depend on a direction dependent loudness perception.

In an embodiment, the processor 120 may, e.g., be configured to synthesize the directional loudness map on a uniformly sampled grid on a surface around a listener depending on positions and energies of the plurality of audio objects.

According to an embodiment, the directional loudness map may, e.g., depend on a grid and one or more falloff curves, which depend on the perceptional coordinate system

In an embodiment, the processor 120 may, e.g., be configured to determine a sum of differences between the three-dimensional directional loudness map and another three-dimensional directional loudness map as the distance metric for the audio sound scene and another audio sound scene.

According to an embodiment, the distance metric may, e.g., depend on the three-dimensional directional loudness map and on the spatial masking model.

In an embodiment, the processor 120 may, e.g., be configured to process the plurality of audio objects to obtain the plurality of audio object clusters. Moreover, the processor 120 may, e.g., be configured to obtain the plurality of audio object clusters by associating each of three or more audio objects of the plurality of audio objects with at least one of the two or more audio object clusters, such that, for each of the two or more audio object clusters, at least one of the three or more audio objects may, e.g., be associated to said audio object cluster, and such that, for each of at least one of the two or more audio object clusters, at least two of the three or more audio objects may, e.g., be associated with said audio object cluster. Furthermore, the processor 120 may, e.g., be configured to obtain the plurality of audio object clusters depending on the distance metric that represents the perceptual differences in the spatial properties of the audio sound scene.

According to an embodiment, the apparatus 100 may, e.g., further comprise an encoding unit. The encoding unit may, e.g., be configured to generate encoded information which encodes the plurality of audio object clusters or the plurality of processed audio objects. And/or, the encoding unit may, e.g., be configured to generate encoded information which encodes the plurality of audio objects of the audio sound scene and information on a perceptual difference between two audio objects of the plurality of audio objects.

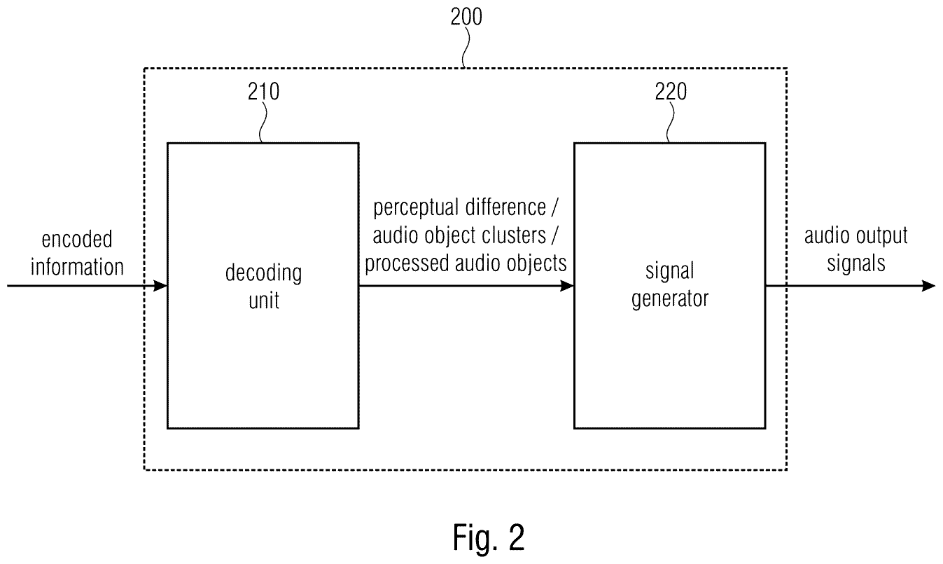

FIG. 2 illustrates a decoder 200 according to an embodiment. The decoder 200 comprises a decoding unit 210 and a signal generator 220.

Each of a plurality of audio objects of an audio sound scene represents a real or virtual sound source being different from any other real or virtual sound source being represented by any other audio object of the plurality of audio objects; or at least two of the plurality of audio objects represent a same real sound source or a same virtual sound source at different locations.

The decoding unit 210 is configured to decode encoded information to obtain a plurality of audio object clusters or a plurality of processed audio objects; wherein the plurality of audio object clusters or the plurality of processed audio objects depends on the plurality of audio objects of the audio sound scene and depends on a distance metric that represents perceptual differences in spatial properties of the audio sound scene; and the signal generator 220 is configured to generate two or more audio output signals depending on the plurality of audio object clusters or depending on the plurality of processed audio objects.

And/or, the decoding unit 210 is configured to decode the encoded information to obtain the plurality of audio objects of the audio sound scene and to obtain information on a perceptual difference between two audio objects of the plurality of audio objects, wherein the perceptual difference depends on a distance metric; and the signal generator 220 is configured to generate the two or more audio output signals depending on the information of the plurality of audio objects and depending on the on the perceptual difference between said two audio objects.

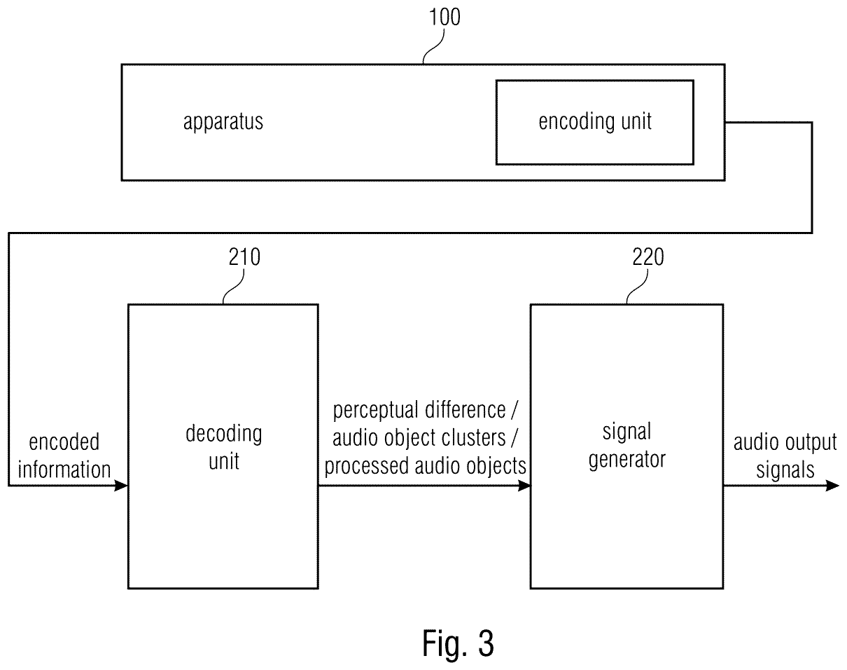

FIG. 3 illustrates a system according to an embodiment. The system comprises the apparatus 100 of FIG. 1.

The apparatus 100 of FIG. 1 further comprises an encoding unit. The encoding unit is configured to generate encoded information which encodes the plurality of audio object clusters or the plurality of processed audio objects. And/or, the encoding unit is configured to generate encoded information which encodes the plurality of audio objects of the audio sound scene and information on a perceptual difference between two audio objects of the plurality of audio objects.

Moreover, the system comprises a decoding unit 210 and a signal generator 220.

The decoding unit 210 is configured to decode the encoded information to obtain the plurality of audio object clusters or the plurality of processed audio objects; and the signal generator (220 is configured to generate two or more audio output signals depending on the plurality of audio object clusters or depending on the plurality of processed audio objects.

And/or, the decoding unit 210 is configured to decode the encoded information to obtain a plurality of audio objects of the audio sound scene and to obtain information on a perceptual difference between two audio objects of the plurality of audio objects; and the signal generator 220 is configured to generate the two or more audio output signals depending on the plurality of audio objects and depending on the perceptual difference between said two audio objects.

In the following, particular embodiments are described in detail.

According to some embodiments, a perceptual distance model is provided.

A task of the developed perceptual distance model is to obtain a distance metric that represents perceptual differences in the spatial properties of a 3D audio sound scene in a computationally efficient way. This may, e.g., be achieved by transforming the geometric coordinates in a coordinate system that considers the direction dependent localization accuracy of human hearing. Furthermore, the distance model may, e.g., incorporate the perceptual properties of the entire scene that contribute localization uncertainty as well as to masking effects.

According to some embodiments, a perceptual coordinate system (PCS) is provided.

The localization accuracy of human spatial hearing is known to be non-uniform. For example, it has been shown that localization accuracy is higher in front of the listener than at the sides, and higher for horizontal localization than for vertical localization, and higher in the front than in the rear of the listener. This property may, e.g., be exploited to optimize perceptual quality e.g. for quantization schemes or object clustering algorithms.

In order to model the non-uniform properties for processing of spatial audio a perceptual coordinate system (PCS) according to an embodiment is provided. The PCS may, e.g., utilize a warped coordinate system in which the distance in the coordinate system (for example, the Euclidean distance) is modeled to correspond to the ‘perceivable difference’ between sound source locations rather than their physical distance. In other words, instead of considering localization accuracy depending on absolute localization, the non-uniform characteristics of perception may, e.g., be represented by warping the coordinate system itself. This is similar to using psychoacoustic frequency scales (e.g., Bark-Scale, or, e.g., ERB-Scale) to represent the non-uniformity of frequency resolution in human hearing.

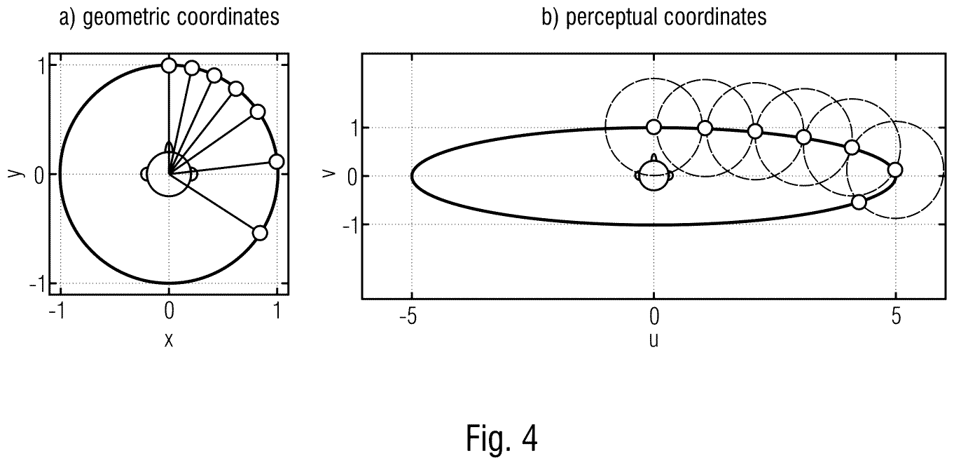

FIG. 4 illustrates a two-dimensional example for a perceptual coordinate system coordinate warping according to an embodiment. In particular, FIG. 4 illustrates a two-dimensional perceptual coordinate warping for sound source positions (dots), spaced by assumed perceptually equal distances in horizontal plane. More particularly, FIG. 4 shows sound source positions separated by perceptually equal distances (e.g. an exemplary JND) in a unit circle in the median plane. For the geometric coordinates in FIG. 4 a) the distance is dependent on the absolute azimuth of the sound sources. For the perceptual coordinates in FIG. 4 b), the positions have been warped, so that the Euclidean distance between the sound sources is constant.

A perceptual coordinate system according to an embodiment may, e.g., enable to approximate perceived differences between arbitrary source positions and to derive updated positions with low computational complexity, e.g., for fast spatial audio processing algorithms, for example, for real-time clustering of object-based audio.

The mapping from geometric to perceptual coordinates is designed to be unique and invertible, e.g., a bijective mapping function. E.g., all computations and updates for sound source positions may, e.g., be performed in the perceptual domain, and the final results may, e.g., be converted back to the physical space domain.

According to an embodiment, a method is provided to derive a PCS based on analysis of HRTF data, e.g., using a model for binaural and spectral localization cues and a multi-dimensional-scaling (MDS) approach on the pairwise differences. This may, e.g., yield a mapping for the grid of positions provided by the analyzed HRTF database, which may, e.g., be used for table-lookup and interpolation. For a closed-form representation, a mapping function may, e.g., be curve-fitted to the analysis grid data and simplified mapping models may, e.g., be derived.

For a generalized PCS model, the analysis may, e.g., be calculated and averaged using HRTF data of many subjects. Furthermore, it should be noted that the presented analysis method may, for example, specifically be calculated for a known HRTF dataset in a target application, e.g. a binaural renderer using generic or personalized HRTF data.

Existing models can estimate localization cues and perceived difference between sound source positions. However, for spatial audio processing algorithms (such as object clustering) those would require repeated calculation of the localization models, which is not computationally efficient and a disadvantage for real-time applications.

By considering and representing the perceptual model in the analysis and construction step of the PCS, computationally expensive parts of the model can be calculated in an offline preprocessing step, which yields a computationally efficient model suitable for real-time processing. Furthermore, using a PCS enables the manipulation of sound source positions directly in the perceptual domain (e.g. optimization of cluster centroids positions).

Additionally since the PCS may, e.g., be modeled based on HRTF data analysis, it can provide a tailored perceptually optimized model for a target application with a given HRTF dataset.

The ‘resolution’ of the human auditory system is different for changes in azimuth and in elevation, and dependent on the absolute position of a sound source.

The baseline model only considers the angle of incidence relative to the listener, e.g., azimuth and elevation, while assuming the distance of the source to be constant (see extensions below for distance model).

The position along the interaural axis (“left/right”) is determined by binaural cues (ICC, ILD, ITD, IPD), resulting in the so-called Cones of Confusion (CoC), along which the binaural cues are approximately constant. It should be noted that when the radius is assumed constant, the cones are reduced to ‘circles of confusion’ along the sphere with a given radius.

Along the CoC, spectral colorations introduced by the pinnae, head and shoulders may, e.g., be used as primary cues for localization of elevation and resolving front/back confusion. It should be noted that the spectral filtering is not necessarily the same for both ears at a given elevation, hence introducing potential additional binaural cues.

To represent this separation of cues, a ‘binaural spherical polar coordinate system’ may, e.g., be employed, where azimuth describes the “left/right” position along the horizontal plane between +90° and elevation describes the “elevation” position along the CoC in the range of 0° . . . 360°, e.g., representing a polar coordinate system where the rotational axis is a aligned with the ear positions, e.g., the poles are located at the left and right positions of the listener, rather than a vertical polar coordinates, where the poles are above/below the listener as they would be in geographic coordinates.

The just noticeable difference (JND) is significantly smaller for azimuth differences (ca 1°) than for elevation (ca. 4° for noise, up to 10-15° for spectrally sparser content). Furthermore, the localization accuracy also depends on absolute position, and is, e.g. more accurate in front than above the listener.

Therefore, neither Euclidean distances between Cartesian coordinate positions (e.g. on the unit sphere), nor angular distances in polar coordinates correspond to the perceived distance.

Even though positions may be represented by a 2D coordinate system (e.g. spanned by azimuth and elevation) that parametrize a 2D surface (e.g. unit sphere sphere), the “wrap-around” properties of a closed, spherical surface (i.e. 360°=) 0° cannot be represented when calculating distances in a 2D coordinate system, hence, a generalized PCS requires (at least) 3 dimensions.

In the following, concepts for generating a PCS are described.

A primary target application for a PCS is to consistently represent the JND of localization accuracy for a given position, e.g. in order to determine if two positions are close enough together so they can be combined into one without the change being perceivable. Therefore, the chosen design goal for a PCS may, e.g., the property that a Euclidean distance of 1 from a given position shall correspond to the JND in the respective direction.

The JND of elevation along the cones of confusion can be predicted from the JND to distinguish spectral differences between the HRTF (see ICASSP19), the JND for azimuth in the horizontal plane can be estimated from the JND for ILD and has been extensively investigated by experiments in literature.

Based on the position dependent JND, a PCS may, e.g., be constructed as an absolute coordinate system that is scaled by accumulating JND between positions. In other words the Euclidean distance between two arbitrary positions may, e.g., correspond to the accumulated number of JNDs in between.

It should be noted that this concept is loosely based on the Weber-Fechner Law. Though the Weber-Fechner Law states a logarithmic relation, the positional distance is measured in the linear domain. However, the considered perceptual cues such as ILD or spectral difference are already measured in a logarithmic domain. For example, when assuming a JND of 1 dB then a PCS distance of 10 JND would correspond to 10 dB.

Based on this concept, according to an embodiment, the perceptual distance (PD)=‘number of JNDs’ between two given positions may, e.g., be calculated from HRTF measurement at the respective positions. Using sets of available HRTF databases, the complete set of pairwise distances between the given HRTF measurement positions may, e.g., be calculated and averaged over a multiple subjects.

This results in a matrix of pairwise perceptual distances between the given grid of geometric input positions.

To derive absolute coordinates from a given set of pairwise differences, a machine learning approach using Multidimensional Scaling (MDS) may, e.g., be employed. Thereby, coordinate/coordinates of a chosen dimensionality, e.g. three-dimensional, that approximate the given distances may, e.g., be calculated.

According to an embodiment, the MDS approach may, e.g., provide a set of PCS positions for the corresponding HRTF measurement's spatial positions.

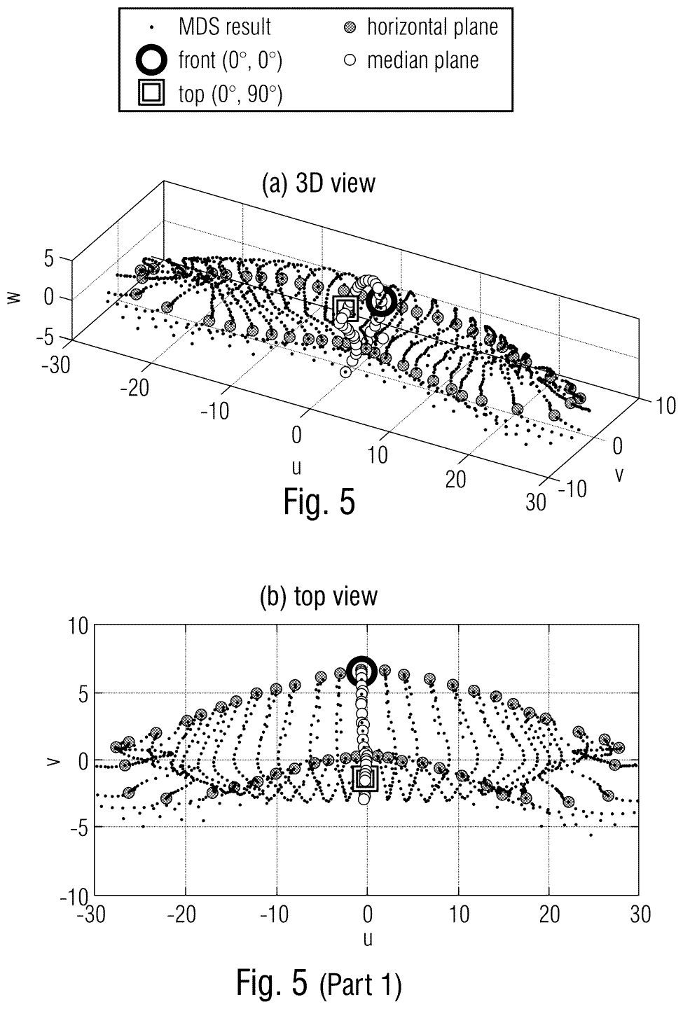

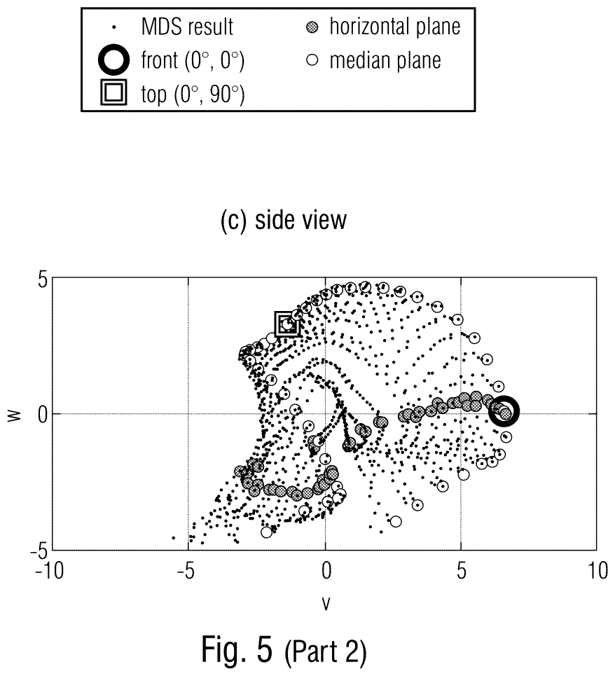

FIG. 5 illustrates perceptual coordinates obtained via a multidimensional scaling of modeled differences in a CIPIC HRTF database according to an embodiment.

In applications where only the grid positions are of interest, the resulting positions may, e.g., be used as a lookup table. For the calculation of distances between arbitrary positions, interpolation in the lookup table may, for example, be employed.

In order to obtain a continuous, closed formula solution in which the PCS coordinates are invertible into geometric coordinates, according to an embodiment, a model of lower dimensionality may, e.g., fitted to the MDS result.

In the following, preprocessing, in particular, alignment of coordinates, according to an embodiment is described.

In such preprocessing, in an embodiment, the MDS coordinates are not inherently aligned with the geometric properties of the input positions (e.g. left-right, front-back).

Since the MDS is based on relative distances, the resulting PCS positions may, e.g., be mirrored, translated and rotated without affecting the fit to the underlying relative distance measurements.

However, for intuitive understanding of the coordinate system, it may, e.g., be advantageous if the PCS coordinates are aligned as far as possible with the actual spatial positions, e.g. a clear correspondence of what is ‘left’, ‘right’, ‘front’, ‘top’.

The MDS may, e.g., result in coordinates that are sorted by their contribution to the variance in the input data set, similar to the energy compaction property in a primary component analysis (PCA).

Since the binaural cues have substantial impact on the perceivable difference and largely have monotonous relation with the azimuth position, typically the first coordinate may, e.g., correspond to the “left/right” axis, though it may be mirrored with respect to the spatial coordinates.

Spectral cues however do not have a unique relation to elevation positions and are subject to a wrap-around, and thus, the MDS result may, e.g., exhibit arbitrary rotation, for example, a coordinate may correspond to an axis pointing from ‘low back’ to ‘top front’, and possibly some deformation between coordinates, see, for example, the ‘D-shape’ of the median plane coordinates in the illustration in FIG. 5.

Therefore, prior to curve fitting, the coordinates from the MDS results may, e.g., be aligned to correspond to desired properties of the geometric coordinates on the unit sphere by means of reflection (e.g. to align left/right inversion), translation (e.g. to align frontal/rear or upper/lower hemisphere) and rotation (e.g. to align points in the horizontal plane).

In the following, a curve fitting approach, in particular, nonlinear regression of polynomials, according to an embodiment is described:

In order to obtain a continuous mapping function from spatial into perceptual coordinates, a curve fitting approach may, e.g., be employed.

According to an embodiment, multi-dimensional nonlinear regression to fit polynomial approximations or spline representations to the MDS results may, e.g., be employed.

However, since the available positons in HRTF databases are typically sparsely sampled, the parametrization may, e.g., be chosen appropriately to avoid overfitting.

Furthermore, most HRTF databases do not contain measurements for the region below the listener. Therefore, great care needs to be taken care that this extrapolated region is well-behaved. Otherwise, for example, the lower-back region can result in large overshoots in spline or polynomial fitting.

In order to preserve the underlying model assumptions of binaural and spectral cues, a separated fitting approach may, e.g., be applied. E.g., an aspect corresponds to the binaural cues, which are clearly separated between left/right and have no “wrap-around”. This is therefore fitted to be represented by a single coordinate. E.g., another aspect corresponds to the monaural spectral cues along the cones of confusion, which inherently comprises a cyclic wrap-around. Therefore, the front/back and up/down axes may, e.g., jointly fitted to represent the cross-section along the cones of confusion.

To avoid overfitting, a linear model is chosen for the first coordinate U (left/right) and a 2^{nd} degree polynomial for the second+third coordinates V and W.

$${u}_{p} ( x ) = 27.8 x$$

$${v}_{p} ( y ) = 8.15 {y}^{4} - 1.75 {y}^{3} - 3.46 {y}^{2} + 4.61 y - 0.6$$

$${w}_{p} ( z ) = - 6.94 {z}^{4} + 4.03 {z}^{3} + 3.11 {z}^{2} + 3.92 z - 1.13$$

The illustration of MDS results (points) and curve fitting (surface) for the CIPIC HRTF database.

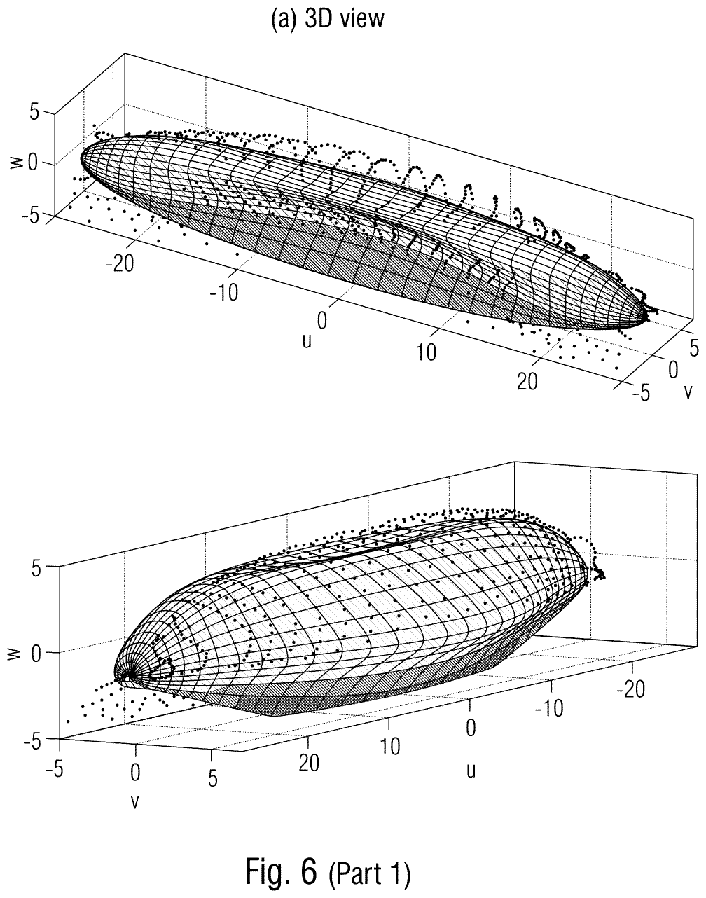

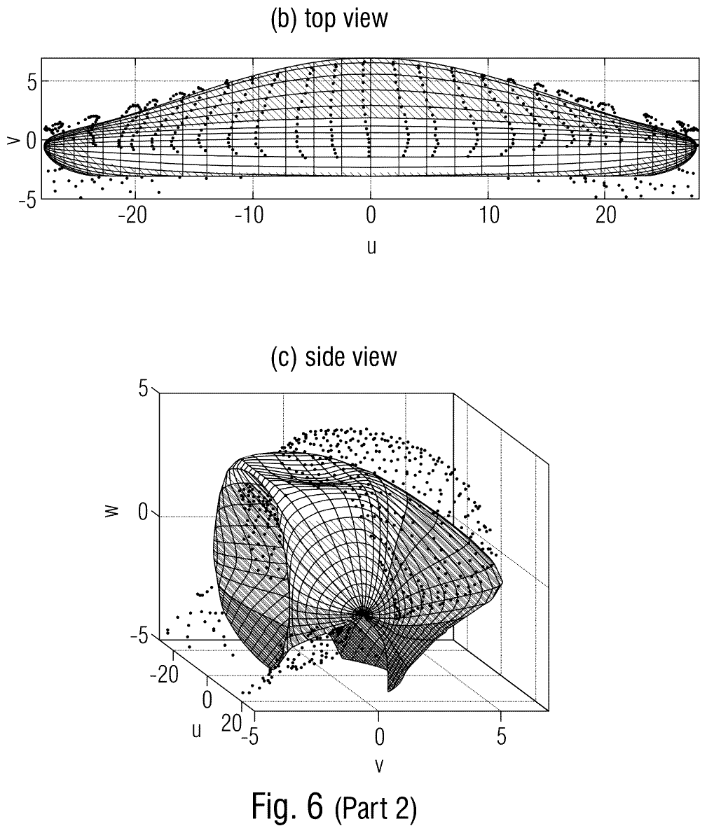

FIG. 6 illustrates a polynomial model based perceptual coordinate system according to an embodiment, wherein the surface represents the warped unit sphere.

In the following, an efficient model fitting approach, in particular, a linear fitting of an ellipsoid, according to an embodiment is described.

Especially for real-time applications, e.g., for real-time object clustering, a computationally simple and efficiently invertible coordinate system is required.

The MDS result and polynomial fitting may, e.g., resemble an ellipsoid, except for the ‘dent’ of the front/back confusion, and the ‘tail’ at the lower-back positions close to the body.

As a simplified model approximation, an ellipsoid may, e.g., be employed.

This may, e.g., be efficiently constructed by scaling the Cartesian coordinates of the unit sphere by appropriate factors. This can also be easily inverted by inverse scaling.

Here, the mapping function may, e.g., be reduced to a scalar scaling of the individual coordinates, with appropriate weights, e.g.,

U=cᵤ*X

V=cᵥ*Y

W=c_{w}*Z

The scaling factors may, e.g., be derived from the MDS results by linear fitting of the respective mapping functions, which may, e.g., be reduced to scalar weighting of the unit sphere's coordinates.

However, the scaling factors for the chosen ellipsoid model may, e.g., directly be fitted to approximate the underlying distance matrix without calculating an MDS.

This reduces computation time and minimizes approximation error, since otherwise two fitting operations would be performed (distance->MDS->ellipsoid)

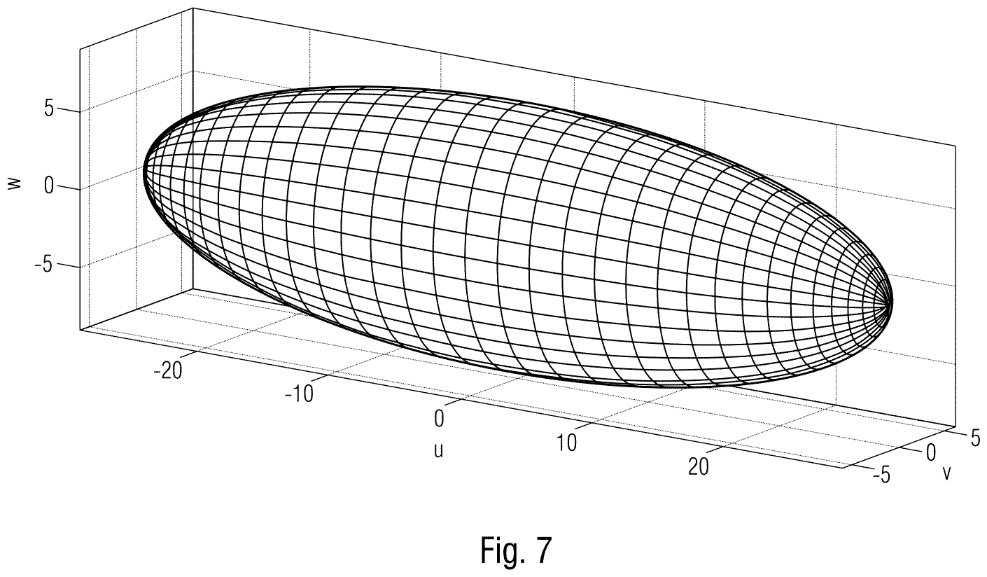

FIG. 7 illustrates an ellipsoid model based perceptual coordinate system according to an embodiment, wherein the surface represents the warped unit sphere.

In the following, an input data selection for parameter fitting according to an embodiment is described.

It should be noted, that generally for the ellipsoid model, a trade-off needs to be considered when choosing the range of input positions: The MDS results may, e.g., exhibit a ‘tail’ at the lower positions, which emphasizes distances between low front and low back. As those positions are separated by the listener's torso, the torso shadowing may, e.g., provide additional spectral cues between those positions and therefore makes them easier to distinguish than front/back in elevated positions.

However, this cannot be represented by an ellipsoid. Therefore, the front/back factor is a compromise between the lower and the upper hemisphere, as there is more prominent front/back confusion in the horizontal plane and elevated positions.

This can be taken into account when the target application scenario (=playback system) is known. E.g. for immersive loudspeaker setups, the loudspeaker positions are predominantly located in the upper hemisphere, thus positions in the lower hemisphere may, e.g., be omitted (or given a lower weight) in the parameter fitting. Conversely, for a VR application, a reproduction of sound sources below the listener is more common, therefore, positions in the lower hemisphere need to be incorporated into the model fitting.

The resulting distortion factors may, e.g., depend, for example, on the database, on an analyzed frequency range, and/or on a considered input. A parameter fitting for the CIPIC HRTF Database results, for example, in c_u=28.1, c_v=5.81, c_w=8.56. A set of averaged factors over multiple HRTF Databases are, for example: c_u=25 (for left/right), c_v=6 (for front/back), cw=5 (for up/down).

For binaural rendering applications in which the reproduction HRTF is known, the PCS may, e.g., be modeled directly to the HRTF in use instead of a generic approximation of a database. The PCS model may, e.g., be updated for real time applications in which the HRTF can be personalized, when a new HRTF set is loaded. Therefore, also a high computational efficiency of the model fitting itself is desirable, as described above.

For more advanced modeling, the PCS may, e.g., be constructed frequency-dependent, for example, to reflect larger HRTF differences for elevation in high frequencies, see Blauert's Directional Bands. This is especially relevant for the coordinates representing spectral cues (V/W). Psychoacoustic experiments in literature show that the left/right localization of physical sound sources is not depending on frequency so much. While the ILD difference is smaller at lower frequencies, the ILD/IPD cues become more relevant. Therefore, a non-frequency dependent scaling of the left/right axis may, e.g., be employed in combination with a frequency dependent scaling along the cones of confusion.

A conversion from geometric coordinates to PCS coordinates may, e.g., be applied in order to transform the location of spatially distributed sound sources in a domain representing perceptual properties of sound source localization in human hearing.

In the PCS domain, the perceptibility of sound source location differences may, e.g., be represented by the Euclidean distance between PCS coordinates. This enables a computationally efficient estimation of perceptual differences in sound source localization.

Furthermore, the PCS domain may, e.g., be calibrated to represent 1 JND as PCS distance of 1. This enables estimating the limits of localization accuracy for any given position. This is applicable e.g. to control the resolution of quantization schemes.

To transform a sound source position given in geometric coordinates (X,Y,Z) into perceptual coordinates (U,V,W), mapping functions may, e.g., be applied, which may, e.g., be in a generic notation:

U=f_{U}(X,Y,Z)

V=f_{V}(X,Y,Z)

W=f_{W}(X,Y,Z)

To transform coordinates back from the perceptual domain into geometric coordinates, inverse mapping functions may, e.g., be applied, which may, e.g., be in generic notation:

X=f⁻¹_{X}(U,V,W)

Y=f⁻¹_{Y}(U,V,W)

Z=f⁻¹_{Z}(U,V,W)

Invertible mapping functions allow to perform operations directly within the perceptual domain, like manipulation of sound source locations and calculation of tolerances. This enables computationally efficient perception based algorithms for processing spatial audio to fully operate directly in the perceptual domain, e.g., without requiring repeated calculation of perceptual models. Resulting spatial positions in the perceptual domain may, e.g., then be transformed back into geometric coordinates via the inverse mapping functions.

Suitable mapping functions are derived as described above.

For computationally efficient implementations, a separable, ellipsoid approximation approach may, e.g., be advantageous, where the mapping functions may, e.g., be simplified to

U=cᵤ*X

V=cᵥ*Y

W=c_{w}*Z

Thus, the inverse mapping functions may, e.g., be simplified to

$$\begin{matrix}Y = U / {c}_{u} \\ Y = V / {c}_{v} \\ Z = W / {c}_{w}\end{matrix}$$

It should be noted that the ellipsoid mapping functions are valid for positions on the unit sphere and corresponding ellipsoid surface. In cases where spatial manipulations result in positions outside the surface, the positions may, e.g., be mapped back onto the defined surface, for example, via projecting to the unit sphere in geometric coordinates, or by selecting the closest point on the ellipsoid surface in the PCS domain.

In the following, a 3D Directional Loudness Map (3D-DLM) according to some embodiments is described.

The purpose of a DLM is to represent ‘how much sound is coming from a given direction’. In other words, it represents the perceived combined loudness from the superposition of all sound sources in a scene, under consideration of localization accuracy of human hearing. In the context of object-based audio, the sound source positions and corresponding signal properties are known. Based thereon, a DLM may, e.g., be calculated as the accumulated contribution of all active sound sources, weighted by a distance-based falloff function, for example, by a Gaussian function or by a linear falloff function.

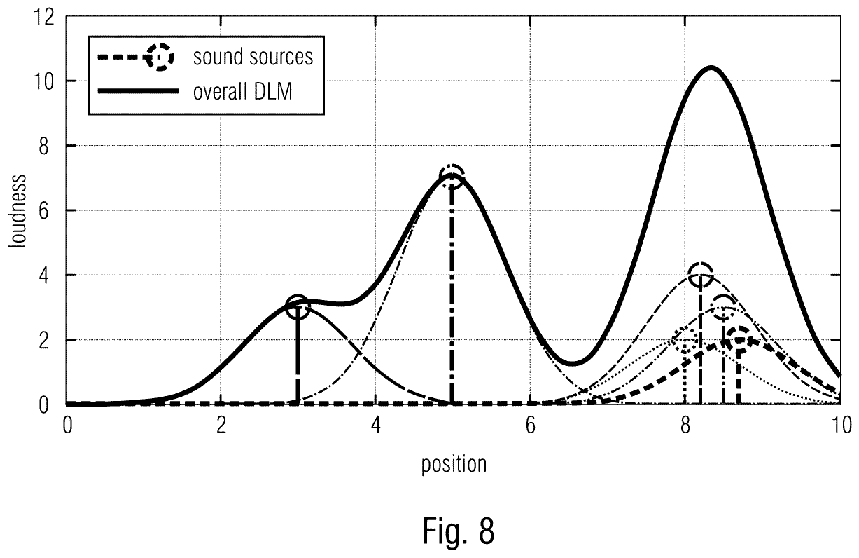

FIG. 8 illustrates an example for the synthesis of a one-dimensional directional loudness map (1D-DLM) based on known object positions and loudness according to an embodiment. It should be noted that this example, e.g., illustrates that the accumulation of the four closely spaced sound sources on the right results in a higher combined loudness than the individually louder sound source around the center position.

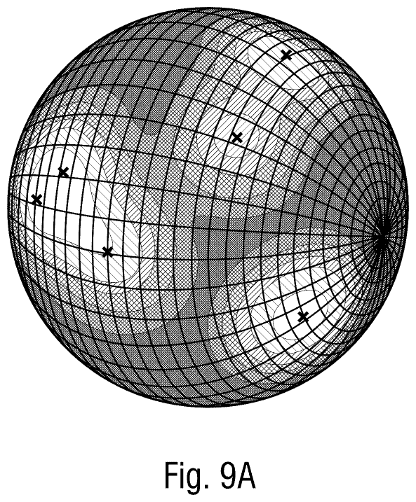

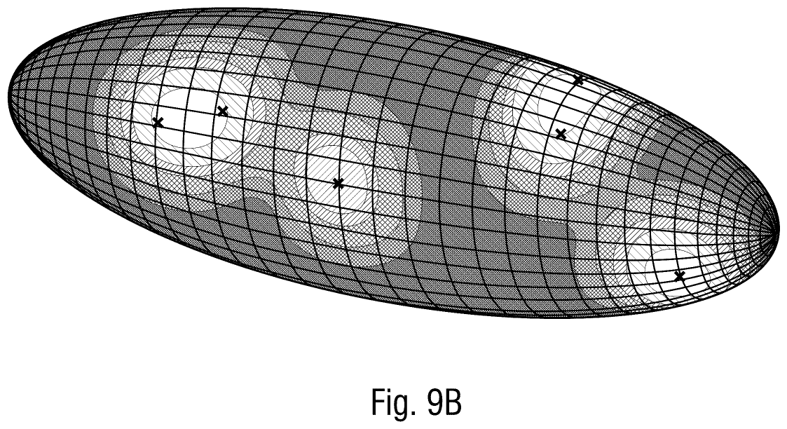

According to an embodiment, the DLM synthesis may, e.g., be extended to localization in 3D space to a 3D-DLM, by using a sampling grid on a surface surrounding the listener (for example, the unit sphere) and calculating the accumulated contributions of all sound sources for each grid point. This results in a 3D-DLM, as illustrated for an example calculation in FIG. 9A and FIG. 9B.

FIG. 9A and FIG. 9B illustrate an example for a 3D-directional loudness map synthesized from known sound source positions (marked x) according to embodiments. FIG. 9A depicts a 3D-DLM on a unit sphere, and FIG. 9B depicts a 3D-DLM in perceptual coordinates.

Known binaural one-dimensional DLM represent the perceived loudness based on binaural cues, i.e. the “left/right” spatial image.

However, according to some embodiments, for immersive audio applications also spatial properties in 3D space like elevation and front/back relations may, e.g., be considered. This may, e.g., be enabled by utilizing a 3D DLM.

Furthermore, the known DLM require a scene analysis step, in which a binaural downmix of the entire sound scene is calculated and processed by a binaural cue analysis to extract the binaural 1D-DLM. In the context of object-based audio, the sound source positions and signal properties such as the signal energy are known a-priori.

According to an embodiment, a 3D-DLM may, e.g., be synthesized directly from this information without requiring the computational complexity of computing a binaural downmix and a scene analysis step.

In the following, a baseline concept for the generation of a 3D-DLM according to an embodiment is provided.

The 3D-DLM may, e.g., be calculated on a grid on a surface around a listener, where each point may, e.g., correspond to a unique spherical coordinate angle, for example, a uniformly sampled unit sphere. Below, more details and different embodiments regarding sampling and surface shape are described.

The energy of each sound source may, e.g., calculated (e.g., as described below) and may, e.g., be spread with a given falloff curve around its position. Following the conventions of the one-dimensional DLM, the falloff curve is modeled after a Gaussian distribution. For low computational complexity, alternatively a linear falloff curve in the logarithmic domain may, e.g., be employed.

The falloff may, e.g., be determined by the Euclidean distance between positions in 3D space, as opposed to the angular distance or distance along the surface of a sphere/ellipsoid, in order to consider perceptual effects such as front/back confusion.

The energy contribution of each sound source, e.g., weighted by the magnitude of the falloff function may, e.g., be calculated for each sound source and each grid point and accumulated for each grid point to calculate the directional energy map (DEM).

This approach assumes uncorrelated sound sources, if correlation between sound sources is expected, a phantom source extraction is performed in a pre-processing step, see, e.g., below. To account for the increased localization blur of phantom sources, the falloff curve may, e.g., be adjusted to represent a wider spread.

From the energy sum at each grid position, the respective loudness may, e.g., be calculated as Energy\hat{ }0.25=sqrt (sqrt (Energy)) as an approximation of the exponent 0.23 given by Zwicker's loudness model.

It should be noted that the summation may, e.g., be done in the energy domain, and, e.g., not in the loudness domain, because in a real-world playback environment, assuming uncorrelated sound sources, the physical energies of the sound sources are superimposed at the ears, rather than the perceptual measurement of loudness.

The spread falloff curve, for example, a standard deviation of the Gaussians, may, e.g., be determined by the psychoacoustics, e.g. corresponding to the JND of localization accuracy.

In order to achieve low computational complexity, for example, for real-time applications, the baseline model for the 3D-DLM may, e.g., be obtained using a time domain energy calculation, for example, frame by frame, e.g., using a full-band energy. In order to incorporate the frequency dependency of human loudness perception, the signal is pre-filtered, for example, using an A-weighting, or, for example, a K-weighting. Otherwise, for example, a high energy in the low frequency region would be over-represented. The perceptual weighting can be implemented computationally efficient e.g. in the form of an IIR filter of relatively low order, for example, a 7^{th} order filter for A-weighting.

Now extensions and further embodiments are considered.

For reduced computational complexity, the falloff curve may, e.g., be truncated, for example, when the tail of the Gaussian is below a given threshold, simpler spread functions can be used, for example, a linear falloff, and falloff curve weights can be buffered and/or pre-calculated for fixed sound source positions that correspond to loudspeaker positions in defined configurations, for example, 5.1, 7.1+4, 22.2.

For advanced perceptual models for applications, where a higher spectral resolution is required, a frequency dependent DLM can be calculated: E.g., the DLM calculation may, e.g., then be performed per spectral band, for example, in ERB resolution. As an extension, for frequency dependent DLM, the spreading factor may, e.g., also be frequency dependent to account for a different localization accuracy of human hearing in different frequency regions.

As an extension, a correlation between the sound sources which result in phantom sound sources is taken into account, for example, when sound sources correspond to two or more channels in a stereo or multi-channel channel-based production. According to an embodiment, a direct signal and diffuse signal part may, e.g., be extracted:

For this purpose, the cross-correlation between the individual channels may, e.g., be calculated.

For correlations above a given threshold, for example, 0.7, a phantom source may, e.g., be inserted and a direct and diffuse part decomposition may, e.g., be performed.

The position of the phantom source may, e.g., be calculated based on the energy ratio between the original sound source positions, e.g. by a weighted average of the positions, or by an inverse panning law, for example, a sine-law panning.

To account for the reduced localization accuracy of phantom sources, the spreading factor of the spatial falloff function may, e.g., be widened for phantom sources by an appropriate factor. This factor may, e.g., be fixed (e.g. 2 JND), or may, e.g., be scaled based on the amount of correlation (i.e. using narrower spread for higher correlation since phantom source is better localizable).

To account for the remaining uncorrelated portion of the signals, e.g., the diffuse part, the overall signal energy may, e.g., be distributed between the additionally inserted phantom source and the original sound source positions, based on the correlation factor.

To account for the diffuse properties of the remaining (uncorrelated) signal portion, the spreading factor for the original sound source positions may, e.g., also be adjusted by an appropriate factor. This factor may, e.g., be fixed, for example, 2 JND, or may, e.g., be scaled based on the amount of correlation, e.g., inverse to spread for phantom sources, e.g., a wider spread for higher correlation since the remaining part corresponds rather to a diffuse field than to a sound source at the original position.

As an extension to account for the “sluggishness” of human hearing regarding temporal localization accuracy, a temporal spreading factor may, e.g., be used, by which the DLM of the previous frame weighted and added to the current frame. The temporal spreading factor may, e.g., be determined by the temporal properties of human hearing and therefore needs to be adapted to the frame length and sample rate.

Now, a sampling grid for a DLM according to an embodiment is described.

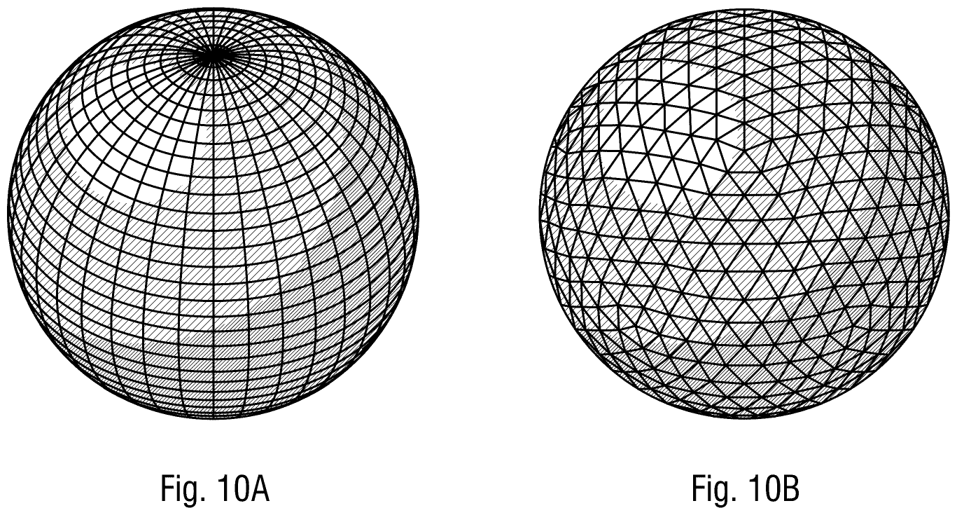

FIG. 10A and FIG. 10B illustrate different sampling methods of a unit sphere grid according to embodiments, wherein FIG. 10A depicts an azimuth/elevation sampling, and wherein FIG. 10B depicts an icosphere. See, e.g., https://en.wikipedia.org/wiki/Geodesic_polyhedron; see also: https://medium.com/@qinzitan/mesh-deformation-study-with-a-sphere-ceee37d47e32.

For a numerical calculation, the DLM may, e.g., be sampled on a grid surrounding the listener. The sampling resolution of the grid is a trade-off between spatial accuracy and computational complexity, and therefore needs to be optimized observing geometric and perceptual properties.

According to an embodiment, generating a grid for calculating the DLM is conducted by uniformly sampling along azimuth and elevation along the unit sphere, for example, 360×180=64.800 points).

However, the spherical coordinates get much denser towards the poles, thus doing non-uniform oversampling, creating an unnecessary high number of points. This leads to a substantial overhead in computational complexity. Moreover, subsequent algorithms (e.g. Gaussian Mixture Models) may, e.g., be impeded by a non-uniform sampling with increased density of values at the poles.

A way of uniformly sampling a sphere (e.g. for computer graphics) may, for example, be a ‘geodesic sphere/polyhedron’, ‘geosphere’ or ‘icosphere’, which is derived by subdividing an icosahedron.

To maintain a resolution of approximately 1°, an icosphere of 5 subdivisions may, for example, be employed, which results in a grid with 10242 points (ca. 16% of uniform grid in azimuth/elevation). This results in a significant reduction in computational and memory requirements while maintaining comparable perceptual quality.

In many applications, even a lower order may, e.g., be sufficient, for example, using only 3 subdivisions which corresponding to 642 points.

In the following, a spatial Masking Model (SMM) according to some embodiments is described.

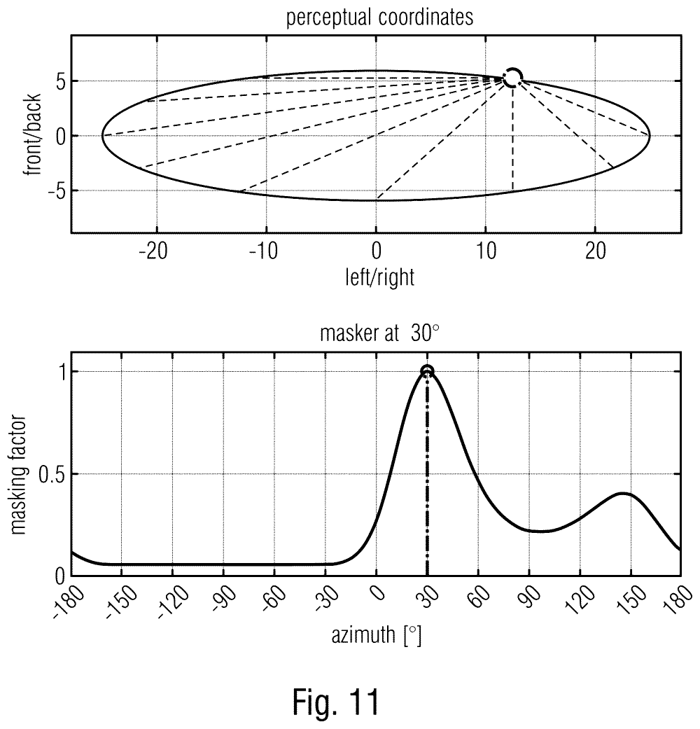

FIG. 11 illustrates a masking model calculation in perceptual coordinates according to an embodiment.

Masking effects that occur in human hearing between loud and soft sounds are an important aspect of psychoacoustic models for audio coding. Existing models typically estimate masking thresholds for mono or stereo coding. However, for immersive audio applications, masking effects between arbitrary sound source positions are of interest. Subjective listening test experiments can typically only cover a limited selection of position pairs for which masking effects are measured. To estimate masking effects between arbitrary sound source positions for immersive audio, a generalized spatial masking model (SMM) according to an embodiment is provided. Findings in subjective experiments suggest that the masking differences may, e.g., be related to the available localization cue, differences and in turn related to localization accuracy. The PCS and 3D-DLM have been introduced as models for localization accuracy and spreading of loudness perception. Based thereon, a spatial masking model for arbitrary sound source positions has been derived, where the distance between sound sources may, e.g., be calculated in the PCS domain to estimate localization cue differences and a spatial falloff curve is applied to model unmasking effects. This is illustrated in FIG. 11 for positions in the median plane, for a masker at −30° azimuth. It can be seen that due to the smaller distance in the PCS representation, stronger masking for the front-back symmetric positions is incorporated while there is substantially less masking for left-right differences, where inter-aural cues contribute more to unmasking.

Masking models may, intended for perceptual audio coding may, e.g., need to be time and frequency dependent in order to control the spectral shaping of introduced quantization noise. Conversely, object clustering affects the spatial position of sound sources. Changing a sound source position as a whole may, e.g., be inherently a ‘full-band’ operation.

It should be acknowledged that masking between individual sound sources may, e.g., still be frequency dependent. However, changing spatial positions of sound sources changes localization cues rather than introducing additional noise. In other words, a masking model for localization changes may, e.g., have different requirements than a masking model for additional signals, for example, quantization noise.

For real-time applications, a computationally efficient model may, e.g., be required, and therefore a simplified, full-band masking model based on time-variant signal energy may, e.g., be applied in the context of object clustering.

To consider the frequency dependent sensitivity of human hearing, a frequency weighting may, e.g., be applied, for example, A-weighting which can be achieved by means of time domain filtering with a relatively short filter, for example, an IIR filter of order 7.

It should be noted that operations that can remove signal components, like culling of inaudible sound sources in the context of object-based audio, advantageously utilize a frequency dependent masking model is used, as this is more similar to the use-case of adding signal components (quantization noise) or removing them (quantization to zero) in perceptual audio coding.

Now, a masking model overview according to some embodiments is provided.

The SMM may, e.g., assume maximal masking thresholds at the position of a masker, e.g., intra-source masking. The masking threshold may, e.g., then be reduced for spatially separate sound sources, weighted by a falloff function depending on spatial distance.

The falloff function may, e.g., be a linear falloff in the logarithmic domain (‘dB per distance’) or, e.g., a Gaussian-shaped falloff curve, which allows to re-use or share the calculations for the DLM in order to save computational complexity.

In addition to the distance-dependent masking, a position independent offset may, e.g., added to the masking thresholds, which is dependent on the total sum of the energies of all sound sources in the scene, weighted by a maximum unmasking factor (e.g. −15 dB). This is done to reflect that there is some remaining amount of masking between sound sources. (Psychoacoustic experiments have found the maximum level of binaural/spatial unmasking is around 15 dB BMLD on headphones.)

In other words: The masking between spatially separated sound sources may, e.g., never fall to zero, as the amount of spatial unmasking is limited (maximum BMLD has been found in literature to be ca. 15 dB on headphone experiments). However, spatial masking experiments show that there is still a rather steep initial falloff for unmasking of spatially separated sound sources, so the falloff curve also needs to reflect that. Thus, especially when using a Gaussian model for falloff curves, the curve should not be chosen to be very wide in order to fit the maximum unmasking at maximum distance, but rather to be steep enough locally around the sound source, but only fall to a given minimum rather than zero afterwards.

Similar to localization accuracy, there may, e.g., be differences in spatial unmasking between horizontal and vertical separation. In order to reflect this, the distance for the falloff curve in the SMM may, e.g., be calculated in the PCS rather than on geometric distance. Thereby, interaural (left/right) differences lead to more unmasking than elevation differences and the considerable masking between front/back symmetric sound sources is retained.

Now, a detailed calculation according to a particular embodiment is described.

A local energy spreading map M_{local}(k) for a sound source that is represented by an object with index k may, e.g., be calculated from the sum of the A-weighted object energies Et for all object indices i weighted, by a Gaussian-shaped falloff function, dependent on the Euclidean distance in the PCS D_{PCS}(k, i) and a (tuneable) spreading factor s, for example, as

$${M}_{local} ( k ) = {\sum }_{i = 0}^{N} {\tilde{E}}_{i} \cdot {e}^{- \frac{{{D}_{P C S} ( k , i )}^{2}}{2 {s}^{2}}}$$

It should be noted that in contrast to the parametrization of a normal distribution density function, the falloff function in the masking model is not normalized, e.g., the spreading factor only scales the width of the distribution, not the height (and therefore the overall sum of the contribution of a sound source). In other words, a higher spread factor means ‘more masking capability’, similar to spreading functions in frequency domain masking. (Especially given the context of DLM calculation, this should not be confused with affecting the overall loudness of a scene.)

Optionally, according to a particular embodiment, the spread factor may, e.g., be chosen to be 2s²=5 for all sound sources (which results in spreading width between 1 and 2 JND considering a resulting corresponding Normal Distribution's standard deviation of, for example, s≙σ=1.58), or alternatively for a wider spread as, for example, s=6 (e.g., 2s²=72).

Moreover, optionally, according to another particular embodiment, as a further improvement of model accuracy, the spread factor can be dependent on the individual object's signal characteristics and masking capabilities (noise-like, tonal, transient, . . . ), when appropriate detectors may, e.g., be available in the given implementation.

In addition to local masking, the minimum remaining masking between sound sources (vice-versa corresponding to maximum binaural unmasking) may, e.g., be incorporated as a global minimum of the energy spreading map Mₘᵢₙ.

According to an embodiment, the minimum masking may, e.g., direction independent. In other words, it may, e.g., reflect the overall sound energy of a scene that limits the ear's resolution capabilities. It can be estimated from the sum of the signal energies weighted by the worst-case BLMD value found in literature of 15 dB [Blauert].

$${M}_{min} = 1 {0}^{- \frac{15}{10}} \cdot {\sum }_{i = 1}^{N} {\tilde{E}}_{i}$$

Alternatively, it may, e.g., be calculated as the sum of the local energy masking maps at the sound source positions, e.g., the sound sources' energy plus the local contributions of neighboring sound sources. This models an increased masking capability of groups of sound sources that are closer together. Furthermore, in case that the spreading factor may, e.g., be modeled signal dependent, this also models sources with a wider spreading factor to have more influence on the overall (minimum) masking.

$${M}_{min} = 1 {0}^{- \frac{15}{10}} \cdot {\sum }_{i = 1}^{N} {M}_{local} ( i )$$

The combined masking threshold Tₖ may, for example, be calculated using 20 dB as an upper estimate for the masking thresholds (from Hellman72 for the case of tone-masking-noise at 60 dB SPL) as

$${T}_{k} = 1 {0}^{- \frac{20}{10}} \cdot ( {M}_{min} + {M}_{local} ( k ) )$$

It should be noted that calculating the combined masking as a sum of local and global masking has the benefit to retain the smoothness of the Gaussian falloff and saturate at an offset. Alternatively, this may, for example, be implemented as a maximum operation between Mₘᵢₙ, M_{local} which allows to cut off the evaluation of the Gaussian function for larger distances (using the energy-only-based calculation of Mₘᵢₙ), and thus to save computational complexity.

In the following, a perceptual distance metric according to some embodiments is described.

The underlying question for a perceptual distance metric in the context of audio object clustering may, e.g., be ‘How perceivable is it, when we combine multiple objects into one?’, which leads to the more detailed question: ‘If we would combine two candidate objects into one, how far would each of the objects be moved, and how audible are the differences introduced by this position changes in the context of the overall scene?’

The PCS provides a model for the perceptibility of spatial position changes of a sound source, while the SMM provides a model for the audibility of a sound source given the masking effects of the overall sound scene. According to an embodiment, these models may, e.g., be combined in order to derive a measurement for the perceptual distance between two sound sources (e.g., objects in this context). Therefore, the perceptual distance between two objects may, e.g., be calculated based on the inter-object distance in the PCS (to consider the localization differences), weighted by an estimate of the perceptual relevance of the objects (in relation to the masking effects in the overall sound scene).

An important concern of such a distance metric is robustness and numerical stability. As real-world implementations operate only with limited numerical precision calculations, the metric may, e.g., be made robust against numerical imprecision and borderline cases such as values close or equal to zero. For example, when the number of active sound sources is varying over time, some audio scene representations may, e.g., comprise metadata and audio for the maximum number of active objects (similar to a fixed number of tracks in a DAW). This results in ‘inactive’ objects where the signal's PCM data only contains digital zeros or (potentially worse) only noise due to numerical imprecision (LSB noise). An advantageous approach may, e.g., be to detect and remove those inactive objects in a pre-processing culling step before the actual clustering; however, this is not feasible in all applications.

Therefore, according to an embodiment, the distance metric may, e.g., designed to be robust for small/zero energies, by adding appropriate offset values where necessary (e.g., without requiring explicit detection of such cases).

Now, a definition of a perceptual distance model according to an embodiment is provided.

In the field of perceptual audio coding, the perceptual entropy (PE) [JJ88] is a well-known measurement to assess ‘how much audible signal content there is in relation to the masking threshold’. Here, a simplified, computationally efficient estimate of the PE of each object may, e.g., be calculated, for example, using full-band energies and masking thresholds derived by the SMM (which may apply a frequency weighting prior to energy calculation to account for frequency dependence of human hearing.

It should be noted that as discussed above, the object positions are not frequency dependent. Hence, a frequency-dependent calculation can improve the accuracy of the masking model, but not add to the degrees of freedom for the clustering algorithm.

The PE of an object of index k may, for example, be calculated as:

$$PE ( i ) = - {log}_{2} ( 1 + \frac{{\tilde{E}}_{k}}{{T}_{k}} )$$

The distance metric D_{Perc}(k, l) between two object indices k, l may, for example, be calculated using the distance in PCS D_{PCS}(k, l) as follows:

$${E}_{offs} = 1 {0}^{- \frac{{thr}_{offs}}{10}} {\sum }_{i = 1}^{N} {\tilde{E}}_{i}$$

$${E}_{s u m} = {\tilde{E}}_{k} + {\tilde{E}}_{l} + 2 {E}_{offs}$$

$${D}_{Perc} ( k , l ) = {D}_{P C S} ( k , l ) \cdot ( {d}_{offs} + \frac{P E ( k ) ( {\tilde{E}}_{l} + {E}_{offs} ) + P E ( l ) ( {\tilde{E}}_{k} + {E}_{offs} )}{{E}_{s u m}} )$$

The model parameters may, for example, be chosen to be thr_{offs}=33 [dB] and d_{offs}=0.1 [bit].

Now, a detailed derivation of the model formula according to an embodiment is described.

To avoid numerical instabilities for small energies, an offset may, e.g., be added to the object energies.

The offset may, e.g., be scaled to the overall energy sum (alternatively: maximum energy), as the range of the energy can span several orders of magnitude depending on the PCM data scaling. E.g., a constant value may, for example, be used for applications with pre-normalized scaling. As an offset, a worst-case estimation masking threshold of −33 dB may, e.g., be chosen (for example, assuming 27 dB for tone-masking-noise+6 dB average BMLD), e.g., plus a constant offset ε depending on the computational precision (e.g. ε=FLT_MIN=1e-37)

$${E}_{offs} = 1 {0}^{- \frac{33}{10}} {\sum }_{i = 1}^{N} {\tilde{E}}_{i} + ε$$

$${E}_{k}^{′} = {\tilde{E}}_{k} + {E}_{offs}$$

When combining two objects, a new centroid c_{k,l} may, e.g., be determined. Here, the position may, e.g., be assumed to be selected as the averaged position, weighted by the objects' energies. Consequently, the centroid position depends on the ratio between the objects' energies. In other words, the positional change for the first object may, e.g., be larger when the second object has more energy, and vice versa. Therefore, the perceived positional distance D_{PCS}(k, c_{k,l}) for a first candidate object of index k to the candidate centroid c_{k,l} may, e.g., be estimated from the ratio of the energy of a second object E′ₗ to the sum of both objects' energies, for example, as

$${D}_{P C S} ( k , c ) = {D}_{P C S} ( k , l ) \frac{{E}_{l}^{′}}{{E}_{k}^{′} + {E}_{l}^{′}}$$

To account for the perceptual relevance of the objects in the context of masking from the entire sound scene, the estimated positional distances may, e.g., be weighted by the objects' PE:

$${D}_{Perc}^{′} ( k , l ) = P E ( k ) {D}_{P C S} ( k , {c}_{k , l} ) + P E ( l ) {D}_{P C S} ( l , {c}_{k , l} )$$

The unit of the distance metric may, e.g., be considered to be ‘Bits times JND’. In this metric, for example, assuming two pairs of candidate objects with the same distance, combining objects with a lower PE may, e.g., be assigned a lower penalty.

To avoid instabilities for objects with negligible PE or energy, an offset which is only dependent on the inter-object distance may, e.g., be added. The offset factor may, e.g., be chosen as 0.1 [bit] (which would correspond to the PE of a signal which is barely above the masking threshold (approx. 0.3 dB=10 log₁₀ 2_{-0.1}).

$${D}_{Perc} ( k , l ) = P E ( k ) {D}_{P C S} ( k , c ) + P E ( l ) {D}_{P C S} ( l , c ) + 0.1 {D}_{P C S} ( k , l )$$

Expanding and simplifying the above equations yields:

$${D}_{Perc} ( k , l ) = {D}_{P C S} ( k , l ) \cdot ( 0. 1 + \frac{P E ( k ) ( {\tilde{E}}_{l} + {E}_{offs} ) + P E ( l ) ( {\tilde{E}}_{k} + {E}_{offs} )}{{\tilde{E}}_{k} + {\tilde{E}}_{l} + 2 {E}_{offs}} )$$

As an extension, a perceptual distance with radius according to an embodiment is described.

The PCS as described above may, e.g., only consider the angle of incidence of a sound source with respect to the listener to model differences in spectral and binaural cues.

However, in various applications (e.g. binaural rendering for VR) the distance between listener and sound source is also of interest.

Therefore, according to an embodiment, an additional coordinate may, e.g., be introduced into the PCS, which is modeled to reflect the JND in radius change.

While judging absolute distance has been shown to be not very accurate, relative changes in distance may, e.g., be detected more easily, e.g., based on three main cues, namely a level change, a direct-to-reverberation-ratio and a Doppler effect.

Regarding the level change, the intensity of a sound source may, e.g., decrease for larger distances (in free-field conditions, the SPL decreases with 1/r\hat{ }2, in closed environments the level decrease is typically lower due to reverberation).

Regarding the direct-to-reverberation-ratio (DRR), in reverberant environments, distant sound sources may, e.g., have more reverberation.

Regarding the Doppler Effect, when the relative distance between listener and a sound source changes with a given velocity, the pitch of the sound source changes due to Doppler Effect.

The cues from level changes and DRR changes are related. In a reverberant environment, the level changes will be reduced, however, additional cues by DRR changes may, e.g., occur.

Hence, an environment-agnostic radial distance model may, e.g., be employed based on the distance-dependent level. Psychoacoustic literature reports a JND of 1 dB for the detection of level changes. Therefore, the radius dependent gain may, e.g., be calculated as a ratio with respect to a reference radius and converted to the logarithmic domain. Thus, 1 dB of relative gain difference directly corresponds to 1 JND of perceivable distance change in this model.

The radial distance coordinate may, for example, be calculated as

$$d\_r = 20 * log 10 ( r / 0.2 + FLT\_MIN )$$

(assuming a reference radius of 0.2m, e.g., close to the head)

A Doppler Effect may, e.g., cause a pitch shift when the distance between sound source and listener changes over time. For a given frequency f and sound source velocity v_S and listener velocity v_L and speed of sound c, the resulting frequency may, e.g., be

$${f}^{′} = f * ( c + v\_L ) / ( c + v\_S )$$

with the signs of v_S, v_L depending on movement towards, or away from each other.

It should be noted that the formula depends on both absolute velocities, not only on the relative velocity. However, for v<<c, it can be simplified by only considering relative velocity.

The human ear is rather sensitive to relative changes in frequency and can detect changes of ca 5 cent (5% of a semitone)

The relative pitch change may, for example, be derived from the Doppler Effect formula

$$\begin{matrix}deltaPitch = 12 * log 2 ( ( c + v\_L ) / ( c + v\_S ) ) [ semitone ] \\ = 1200 * log 2 ( ( c + v\_L ) / ( c + v\_S ) ) [ cent ]\end{matrix}$$

Solving the formula for Doppler pitch shift for a JND of 5 cent yields a JND of ca 1 m/s for both listener and source movement (at low velocity).

Therefore, the velocity component for the PCS may, e.g., be directly modeled after the relative velocity between listener and sound source, with 1 m/s being equal to 1 JND.

In the following, further embodiments are provided.

According to a first embodiment, a distance metric that represents perceptual differences in the spatial properties of a 3D audio sound scene is provided.

According to a second embodiment, a perceptual coordinate system (PCS), wherein geometric distances, e.g., Euclidean or angular distances, represent perceivable localization differences according to the first embodiment is provided.

According to a first variant of the second embodiment, a parametric, invertible mapping function to transform geometric (physical) coordinates in the perceptual coordinate system of the second embodiment is provided.

According to a particular variant of the second embodiment, a method to derive mapping parameters of the first variant of the second embodiment based on analysis of HRTF data is provided.

According to a third embodiment, a masking model for spatially distributed sound sources using spatial falloff-curves based on perceptual distances of the second embodiment is provided.

In a first variant of the third embodiment, a masking model of the third embodiment using Gaussian falloff curves with an offset for minimum masking is provided.

In a second variant of the third embodiment, a calculation of masking effects of entire sound scene as sum of monaural masking thresholds weighted by position dependent masking model of the third embodiment is provided.

In a third variant of the third embodiment, an estimation of the contribution of a sound source to the sound scene information based on the Perceptual Entropy (PE) calculated from the masking model of the third embodiment and the sound source energy is provided.

In a fourth variant of the third embodiment, an identification of inaudible sound sources for culling of irrelevant audio objects is provided.

According to a fourth embodiment, a perceptual distortion metric (PDM) for changes in the spatial properties of a 3D audio sound scene based on perceptual distances of the second embodiment and the spatial masking model of the third embodiment is provided.

According to a first variant of the fourth embodiment, a distortion metric for position change of a single sound source as weighted combination of PCS distance and PE from masking model is provided.

According to a second variant of the fourth embodiment, a distortion metric for the consolidation of two or more sound sources, based on estimated centroid position and weighted sum of individual distortion metrics

According to a fifth embodiment, 3D Directional Loudness Map (3D-DLM) to represent direction dependent loudness perception is provided.

According to a first variant of the fifth embodiment, synthesizing a 3D-DLM for known sound source positions and energies on a uniformly sampled grid on a surface around the listener is conducted.

According to a second variant of the fifth embodiment, a 3D-DLM based on a grid and falloff curves in PCS coordinates of the second embodiment is provided.

According to a third variant of the fifth embodiment, a sum of differences between two 3D-DLM as distortion metric of the first embodiment for two sound scene representations is provided.

According to a fourth variant of the fifth embodiment, a combination of 3D-DLM and masking model of the third embodiment as PE-based difference metric between two sound scene representations is provided.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An apparatus, comprising:
an input interface for receiving a plurality of audio objects of an audio sound scene, and
a processor,
wherein each of the plurality of audio objects represents a sound source being different from any other sound source being represented by any other audio object of the plurality of audio objects; or wherein at least two of the plurality of audio objects represent a same sound source at different locations;
wherein the processor is configured to acquire information on a perceptual difference between two audio objects of the plurality of audio objects depending on a distance metric, wherein the distance metric represents perceptual differences in spatial properties of the audio sound scene; and/or
wherein the processor is configured to process the plurality of audio objects to acquire a plurality of audio object clusters or a plurality of processed audio objects depending on the distance metric.

2. An apparatus according to claim 1,
wherein the audio sound scene is a three-dimensional audio sound scene.

3. An apparatus according to claim 1,
wherein the processor is configured to acquire the information on a perceptual difference between two audio objects depending on a perceptual coordinate system; and/or wherein the processor is configured to process the plurality of audio objects to acquire the plurality of audio object clusters or the plurality of processed audio objects depending on the perceptual coordinate system,
wherein distances in the perceptual coordinate system represent perceivable localization differences.

4. An apparatus according to claim 3,
wherein the processor is configured to acquire the information on a perceptual difference between two audio objects depending on an invertible mapping function; and/or wherein the processor is configured to process the plurality of audio objects to acquire the plurality of audio object clusters or the plurality of processed audio objects depending on the invertible mapping function,
wherein the processor is configured to employ the invertible mapping function to transform coordinates of a physical coordinate system into coordinates of the perceptual coordinate system.

5. An apparatus according to claim 4,
wherein the invertible mapping function depends on head-related transfer function data.

6. An apparatus according to claim 3,
wherein the processor is configured to acquire the information on a perceptual difference between two audio objects depending on a spatial masking model for spatially distributed sound sources; and/or wherein the processor is configured to process the plurality of audio objects to acquire the plurality of audio object clusters or the plurality of processed audio objects depending on the spatial masking model,
wherein the spatial masking model depends on a masking threshold,
wherein the processor is configured to determine the masking threshold depending on a falloff function, and depending on one or more distances in the perceptual coordinate system.

7. An apparatus according to claim 6
wherein the processor is configured to determine the masking threshold depending on a Gaussian-shaped falloff function as the falloff function and depending on an offset for minimum masking.

8. An apparatus according to claim 6,
wherein the processor is configured to identify one or more inaudible audio objects among the plurality of audio objects.

9. An apparatus according to claim 6,
wherein the processor is configured to acquire the information on a perceptual difference between two audio objects depending on a perceptual distortion metric; and/or wherein the processor is configured to process the plurality of audio objects to acquire the plurality of audio object clusters or the plurality of processed audio objects depending on the perceptual distortion metric,
wherein the processor is configured to determine the perceptual distortion metric depending on distances in the perceptual coordinate system and depending on the spatial masking model.

10. An apparatus according to claim 9,
wherein the processor is configured to determine the perceptual distortion metric depending on a perceptual entropy of one or more of the plurality of audio objects.

11. An apparatus according to claim 10,
wherein the processor is configured to determine the perceptual distortion metric depending on a first distance between a first one of two audio objects of the plurality of audio objects and a centroid of the two audio objects, and depending on a second distance between a second one of the two audio objects and the centroid of the two audio objects.

12. An apparatus according to claim 3,
wherein the processor is configured to acquire the information on a perceptual difference between two audio objects depending on a three-dimensional directional loudness map; and/or wherein the processor is configured to process the plurality of audio objects to acquire the plurality of audio object clusters or the plurality of processed audio objects depending on the directional loudness map,
wherein the three-dimensional directional loudness map depends on a direction dependent loudness perception.

13. An apparatus according to claim 12,
wherein the processor is configured to synthesize the directional loudness map on a uniformly sampled grid on a surface around a listener depending on positions and energies of the plurality of audio objects.

14. An apparatus according to claim 12,
wherein the directional loudness map depends on a grid and one or more falloff curves, which depend on the perceptional coordinate system.

15. An apparatus according to claim 12,
wherein the processor is configured to determine a sum of differences between the three-dimensional directional loudness map and another three-dimensional directional loudness map as the distance metric for the audio sound scene and another audio sound scene.

16. An apparatus according to claim 12,
wherein the processor is configured to acquire the information on a perceptual difference between two audio objects depending on a spatial masking model for spatially distributed sound sources; and/or wherein the processor is configured to process the plurality of audio objects to acquire the plurality of audio object clusters or the plurality of processed audio objects depending on the spatial masking model,
wherein the spatial masking model depends on a masking threshold,
wherein the processor is configured to determine the masking threshold depending on a falloff function, and depending on one or more distances in the perceptual coordinate system,
wherein the distance metric depends on the three-dimensional directional loudness map and on the spatial masking model.

17. An apparatus according to claim 1,
wherein the processor is configured to process the plurality of audio objects to acquire the plurality of audio object clusters,
wherein the processor is configured to acquire the plurality of audio object clusters by associating each of three or more audio objects of the plurality of audio objects with at least one of the two or more audio object clusters, such that, for each of the two or more audio object clusters, at least one of the three or more audio objects is associated to said audio object cluster, and such that, for each of at least one of the two or more audio object clusters, at least two of the three or more audio objects are associated with said audio object cluster,
wherein the processor is configured to acquire the plurality of audio object clusters depending on the distance metric that represents the perceptual differences in the spatial properties of the audio sound scene.

18. An apparatus according to claim 1, wherein the apparatus further comprises an encoding unit,
wherein the encoding unit is configured to generate encoded information which encodes the plurality of audio object clusters or the plurality of processed audio objects; and/or
wherein the encoding unit is configured to generate encoded information which encodes the plurality of audio objects of the audio sound scene and information on a perceptual difference between two audio objects of the plurality of audio objects.

19. A system, comprising:
an apparatus according to claim 18,
a decoding unit, and
a signal generator,
wherein the decoding unit is configured to decode the encoded information to acquire the plurality of audio object clusters or the plurality of processed audio objects; and wherein the signal generator is configured to generate two or more audio output signals depending on the plurality of audio object clusters or depending on the plurality of processed audio objects; and/or
wherein the decoding unit is configured to decode the encoded information to acquire a plurality of audio objects of the audio sound scene and to acquire information on a perceptual difference between two audio objects of the plurality of audio objects; and wherein the signal generator is configured to generate the two or more audio output signals depending on the plurality of audio objects and depending on the perceptual difference between said two audio objects.

20. A decoder, comprising:
a decoding unit; and
a signal generator;
wherein each of a plurality of audio objects of an audio sound scene represents a sound source being different from any other sound source being represented by any other audio object of the plurality of audio objects; or at least two of the plurality of audio objects represent a same sound source at different locations;
wherein the decoding unit is configured to decode encoded information to acquire a plurality of audio object clusters or a plurality of processed audio objects; wherein the plurality of audio object clusters or the plurality of processed audio objects depends on the plurality of audio objects of the audio sound scene and depends on a distance metric that represents perceptual differences in spatial properties of the audio sound scene; and wherein the signal generator is configured to generate two or more audio output signals depending on the plurality of audio object clusters or depending on the plurality of processed audio objects; and/or
wherein the decoding unit is configured to decode the encoded information to acquire the plurality of audio objects of the audio sound scene and to acquire information on a perceptual difference between two audio objects of the plurality of audio objects, wherein the perceptual difference depends on a distance metric; and wherein the signal generator is configured to generate the two or more audio output signals depending on the plurality of audio objects and depending on the perceptual difference between said two audio objects.

21. A method, comprising:
receiving a plurality of audio objects of an audio sound scene, and
acquiring information on a perceptual difference between two audio objects of the plurality of audio objects depending on a distance metric,
wherein each of the plurality of audio objects represents a sound source being different from any other sound source being represented by any other audio object of the plurality of audio objects; or wherein at least two of the plurality of audio objects represent a same sound source at different locations;
wherein the distance metric represents perceptual differences in spatial properties of the audio sound scene; and/or processing the plurality of audio objects to acquire a plurality of audio object clusters or a plurality of processed audio objects depending on the distance metric.

22. A method, wherein each of the plurality of audio objects represents a sound source being different from any other sound source being represented by any other audio object of the plurality of audio objects; or at least two of the plurality of audio objects represent a same sound source at different locations; wherein the method comprises:
decoding encoded information to acquire a plurality of audio object clusters or a plurality of processed audio objects; wherein the plurality of audio object clusters or the plurality of processed audio objects depends on the plurality of audio objects of the audio sound scene and depends on a distance metric that represents perceptual differences in spatial properties of the audio sound scene; and generating two or more audio output signals depending on the plurality of audio object clusters or depending on the plurality of processed audio objects; and/or
decoding the encoded information to acquire the plurality of audio objects of the audio sound scene and to acquire information on a perceptual difference between two audio objects of the plurality of audio objects, wherein the perceptual difference depends on a distance metric; and generating the two or more audio output signals depending on the plurality of audio objects and depending on the perceptual difference between said two audio objects.

23. A non-transitory digital storage medium having a computer program stored thereon to perform the method comprising:
receiving a plurality of audio objects of an audio sound scene, and
acquiring information on a perceptual difference between two audio objects of the plurality of audio objects depending on a distance metric,
wherein each of the plurality of audio objects represents a sound source being different from any other sound source being represented by any other audio object of the plurality of audio objects; or wherein at least two of the plurality of audio objects represent a same sound source at different locations;
wherein the distance metric represents perceptual differences in spatial properties of the audio sound scene; and/or processing the plurality of audio objects to acquire a plurality of audio object clusters or a plurality of processed audio objects depending on the distance metric,
when said computer program is run by a computer.

24. A non-transitory digital storage medium having a computer program stored thereon to perform the method, wherein each of the plurality of audio objects represents a sound source being different from any other sound source being represented by any other audio object of the plurality of audio objects; or at least two of the plurality of audio objects represent a same sound source at different locations; wherein the method comprises:
decoding encoded information to acquire a plurality of audio object clusters or a plurality of processed audio objects; wherein the plurality of audio object clusters or the plurality of processed audio objects depends on the plurality of audio objects of the audio sound scene and depends on a distance metric that represents perceptual differences in spatial properties of the audio sound scene; and generating two or more audio output signals depending on the plurality of audio object clusters or depending on the plurality of processed audio objects; and/or
decoding the encoded information to acquire the plurality of audio objects of the audio sound scene and to acquire information on a perceptual difference between two audio objects of the plurality of audio objects, wherein the perceptual difference depends on a distance metric; and generating the two or more audio output signals depending on the plurality of audio objects and depending on the perceptual difference between said two audio objects,
when said computer program is run by a computer.
